(19) United States
(12) Patent Application Publication
(10) Pub. No.: US 2026/0011150 A1
(43) Pub. Date: Jan. 8, 2026

(54) EVENT EVOLUTION

(71) Applicant: SimpliSafe, Inc., Boston, MA (US)

(72) Inventors: Nadeem Hussain, Worcester, MA (US); Jessica Pitocco, Arlington, MA (US); Alice Chiang, Arlington, MA (US); Madeleine Fougere, Seattle, WA (US); Irene Lee, Boston, MA (US)

(21) Appl. No.: 19/259,564

(22) Filed: Jul. 3, 2025

Related U.S. Application Data
(60) Provisional application No. 63/668,002, filed on Jul. 5, 2024.

(51) Int. Cl. G06V 20/40; G06F 3/04817; G06V 20/52; G06V 40/16; G06V 40/20

(52) U.S. Cl. CPC G06V 20/44; G06F 3/04817; G06V 20/52; G06V 40/161; G06V 40/20; G06V 2201/07

(57) ABSTRACT

A method including obtaining data about an event flagged for handling by at least one monitoring professional, the event being detected by a sensor at a location; identifying, based on the data, an action taken concerning the event; and updating a card based on the action taken, the card being representative of the event within a graphical user interface and including at least one of an icon representative of a type of the event or a control indicating a number of faces of humans detected during the event and selectable to access one or more images depicting the faces of the humans.

### CROSS-REFERENCE TO RELATED APPLICATIONS

This application claims priority under 35 U.S.C. § 119(e) to co-pending U.S. Provisional Application No. 63/668,002, titled “TIMELINE EVENT DISPLAYS”, and filed on Jul. 5, 2024, which is hereby incorporated herein by reference in its entirety.

### TECHNICAL FIELD

Aspects of the technologies described herein relate to monitoring systems and methods, and more particularly, to initial notifications and ongoing updates of events detected and handled by monitoring systems and methods.

### BACKGROUND

Some monitoring systems use one or more cameras to capture images of areas around or within a residence or business location. Such monitoring systems can process images locally and transmit the captured images to a remote service. If motion is detected, the monitoring systems can send an alert to one or more user devices.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this disclosure. However, the figures are not intended as a definition of the limits of any particular example. The figures, together with the remainder of this disclosure, serve to explain principles and operations of the described and claimed aspects. In the figures, the same or similar components that are illustrated are represented by a like reference numeral. For purposes of clarity, every component may not be labeled in every figure. In the figures:

FIG. 1 is a schematic diagram of a security system, according to some examples described herein;

FIG. 2 is a schematic diagram of a base station, according to some examples described herein;

FIG. 3 is a schematic diagram of a keypad, according to some examples described herein;

FIG. 4A is a schematic diagram of a security sensor, according to some examples described herein;

FIG. 4B is a schematic diagram of an image capture device, according to some examples described herein;

FIG. 4C is a schematic diagram of another image capture device, according to some examples described herein;

FIG. 4D is a schematic diagram of another image capture device, according to some examples described herein;

FIG. 5 is a schematic diagram of a data center environment, a monitoring center environment, and a customer device, according to some examples described herein;

FIG. 6 is a sequence diagram of a monitoring process, according to some examples described herein;

FIG. 7 is a schematic diagram of select portions of the security system of FIG. 1 that are configured to implement a graphical user interface (GUI) with an event timeline including dynamic event cards, according to some examples described herein;

FIG. 8 is a diagram illustrating an example of a GUI for displaying dynamic event cards that correspond to remote monitoring events that have been logged by a system, according to some examples described herein;

FIG. 9 is a diagram of one example of a dynamic event card that can be rendered on a GUI, according to some examples described herein;

FIG. 10 is a diagram illustrating an architecture of devices that can interact with each other to produce an event timeline including dynamic event cards, according to some examples described herein;

FIG. 11 is a diagram illustrating an example of an event timeline including dynamic event cards, according to some examples described herein;

FIG. 12 is a sequence diagram illustrating an example of a process flow for generating and updating dynamic event cards, according to some examples described herein;

FIG. 13 is a flow diagram illustrating a motion event lifecycle, according to some examples described herein;

FIG. 14 is a schematic diagram of a computing device, according to some examples described herein; and

FIG. 15 is a schematic diagram of processes involved in establishing and conducting real time communication sessions, according to some examples disclosed herein.

### DETAILED DESCRIPTION

At least some examples disclosed herein are directed to systems and processes for providing transparency into remote access of devices in distributed or otherwise remote systems (e.g., security systems) and for providing users with up-to-date information about events (e.g., a motion event) detected or identified by a sensor, such as a motion-sensitive camera, for example. Various examples relate to indoor or outdoor cameras, motion detection, automated tagging of movement types, actions taken by monitoring personnel, and the display of annotated information to a user viewing a history of events at their location.

As described in more detail below, a system (e.g., a security system, monitoring system etc.) can include one or more devices (e.g., motion-sensitive cameras) that can record still and/or video images at a monitored location. In some examples, a customer can use a computer or mobile application to view a live or recorded camera video feed from virtually anywhere an Internet connection is available. In some examples, the device, the application, or a monitoring agency with access to the video feed, can automatically process the video to detect events such as motion and the presence of people or objects and send alerts of the events to the user. When certain events occur, such as a person being detected by a camera at the monitored location or an alarm being triggered by the camera or by another sensor at the monitored location, the monitoring agency may remotely access one or more cameras or other sensors at a customer location and optionally take further actions, such as notifying the customer, law enforcement, emergency services, or another entity.

To provide the customer with transparency about such access, in some examples, various events associated with access and monitoring of a customer's security system by a monitoring agency are logged for review by the customer. For example, events indicative of activity by a monitoring agency professional, including actions taken by the monitoring professional on behalf of the customer, can be recorded to a user-accessible log and reported to the customer via a timeline (e.g., an event timeline), which provides the user with information regarding the monitoring agency professional activities. Such activities include, for example, monitoring professional access to the camera, monitoring professional viewing the camera, monitoring professional interacting with the camera (such as enabling bi-directional audio communications), and monitoring professional terminating camera access. The customer can review the timeline of events, along with other information regarding their system, via a GUI of a computing device such as a personal computer or smartphone.

In some examples, the timeline provides a record of happenings at a monitored location, and individual events are discrete points in time where something occurred. Events may include records of actions such as when a user arms their system, denoting when a test signal was received from the base station, notifying the user when a person was detected by a camera at the monitored location, or logging an action taken by a monitoring professional, for example. The timeline may allow the customer to remain informed about current actions taken by the monitoring agency via events logged to the timeline. Through the timeline, users can view real time updates that occur during handling of an event or collection of events, including an alarm, for example. As described further below, the timeline may include messages, alerts, or other information presented via a GUI of an application executing on a computer, smartphone, or other such device. The timeline includes, for example, descriptions of various events associated with or otherwise indicative of actions taken by the monitoring agency professionals along with the date and time that individual events occurred. The events can be displayed in a chronological format so that they appear sorted in the sequence that they occurred. The user can review the events to better understand what actions were taken by the monitoring agency when responding to an alarm or other event or incident (e.g., beginning and ending camera access) and, in some examples, provide links to video and/or audio that was recorded contemporaneously with the actions taken by the monitoring agency professional so that the user can see and hear what the monitoring agency professional saw and heard while remotely interacting with the cameras.

As described further below, according to certain examples, through the timeline, a user can be provided with the most recent information about a motion event detected by a camera or other device. As a monitoring professional looks at a live stream or recording, their understanding of what is happening may change. Examples disclosed herein provide techniques by which to inform the user as accurately as possible about what the monitoring professional is doing and how the monitoring professional handled the event.

For instance, in some examples, the timeline may include at least one event card that is dynamically updated as information develops regarding a corresponding event. In these examples, the event card may initially indicate information regarding a trigger of an event (e.g., motion detected, a threshold change in humidity, glass breakage, a threshold change in temperature, etc.). Subsequently, the same event card may be updated or otherwise changed in place to indicate contemporaneous information regarding how the event is being handled (e.g., monitoring agency notified, monitoring professional reviewing scene, monitoring professional contacting emergency services, etc.). Later still, the same event card may indicate information regarding a final disposition of the event (e.g., event categorized as common, event canceled by customer, event canceled by monitoring professional, police dispatched to scene, etc.). By presenting dynamic event cards in this manner, the processes and systems described herein provide users with current information and status regarding events within a comprehensive, yet compact, timeline; thereby making efficient use of the limited screen size common in many smartphones and other computing devices.

Accordingly, in one example, a method is provided. The method includes detecting an event with a sensor (e.g., detecting a motion event with a camera), generating an event card for the event, displaying the event card via a GUI, obtaining updated information pertaining to the event, and updating the event card to reflect an updated status of the event. In some examples, the GUI can be presented on a user's computing device (e.g., a mobile phone or tablet) through a mobile application (“app”), and updates to the event card can be performed while the event is ongoing (e.g., in real time) and while a user is using the app.

These and other aspects and examples are described in more detail below.

Whereas various examples are described herein, it will be apparent to those of ordinary skill in the art that many more examples and implementations are possible. Accordingly, the examples described herein are not the only possible examples and implementations. Furthermore, the advantages described above are not necessarily the only advantages, and it is not necessarily expected that all of the described advantages will be achieved with every example.

For the purposes of promoting an understanding of the principles of the present disclosure, reference will now be made to the examples illustrated in the drawings, and specific language will be used to describe the same. It will nevertheless be understood that no limitation of the scope of the examples described herein is thereby intended.

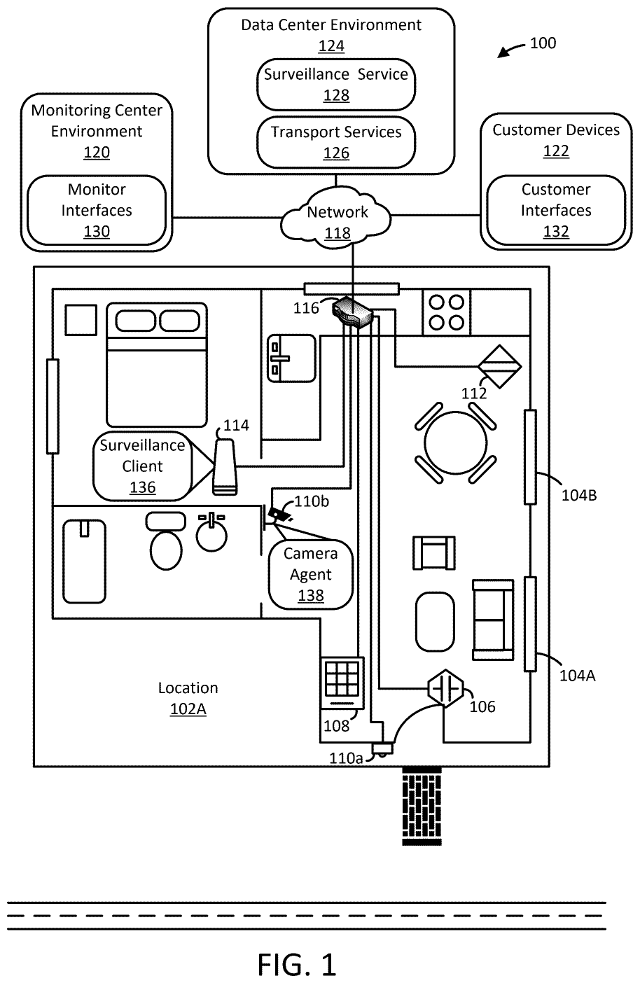

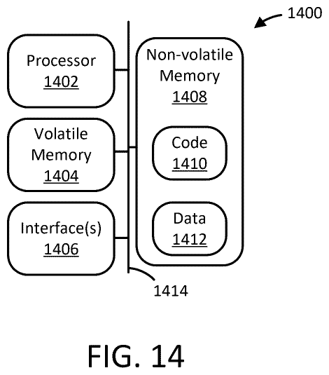

FIG. 1 is a schematic diagram of a security system 100 configured to monitor geographically disparate locations in accordance with some examples. As shown in FIG. 1, the system 100 includes various devices disposed at a monitored location 102A, a monitoring center environment 120, a data center environment 124, one or more customer devices 122, and a communication network 118. Each of the monitoring center environment 120, the data center environment 124, the one or more customer devices 122, and the communication network 118 include one or more computing devices (e.g., as described below with reference to FIG. 14). Some or all of the devices disposed at the monitored location 102A may also include one or more computing devices. The one or more customer devices 122 are configured to host one or more customer interface applications 132. The monitoring center environment 120 is configured to host one or more monitor interface applications 130. The data center environment 124 is configured to host a surveillance service 128 and one or more transport services 126. In some examples, devices at the monitored location 102A include one or more image capture devices 110 (individually identified as image capture devices 110a and 110b in FIG. 1), a contact sensor assembly 106, a keypad 108, a motion sensor assembly 112, a base station 114, and a router 116. The base station 114 hosts a surveillance client 136. The image capture device 110 hosts a camera agent 138. The security devices disposed at the monitored location 102A (e.g., devices 106, 108, 110, 112, and 114) may be referred to herein as location-based devices.

In some examples, the router 116 is a wireless router that is configured to communicate with the location-based devices via communications that comport with a communications standard such as any of the various Institute of Electrical and Electronics Engineers (IEEE) 802.11 standards. As illustrated in FIG. 1, the router 116 is also configured to communicate with the network 118. It should be noted that the router 116 implements a local area network (LAN) within and proximate to the monitored location 102A by way of example only. Other networking technology that involves other computing devices is suitable for use within the location 102A. For instance, in some examples, the base station 114 can receive and forward communication packets transmitted by the image capture device 110 via a personal area network (PAN) protocol, such as BLUETOOTH. Additionally or alternatively, in some examples, the location-based devices communicate directly with one another using any of a variety of standards suitable for point-to-point use, such as any of the IEEE 802.11 standards, PAN standards, etc. In at least one example, the location-based devices can communicate with one another using a sub-GHz wireless networking standard, such as IEEE 802.11ah, Z-WAVE, ZIGBEE, etc.). Other wired, wireless, and mesh network technology and topologies will be apparent with the benefit of this disclosure and are intended to fall within the scope of the examples disclosed herein.

Continuing with the example of FIG. 1, the network 118 can include one or more public and/or private networks that support, for example, IP. The network 118 may include, for example, one or more LANs, one or more PANs, and/or one or more wide area networks (WANs). The LANs can include wired or wireless networks that support various LAN standards, such as a version of IEEE 802.11 and the like. The PANs can include wired or wireless networks that support various PAN standards, such as BLUETOOTH, ZIGBEE, and the like. The WANs can include wired or wireless networks that support various WAN standards, such as the Code Division Multiple Access (CDMA) radio standard, the Global System for Mobiles (GSM) radio standard, and the like. The network 118 connects and enables data communication between the computing devices within the monitored location 102A, the monitoring center environment 120, the data center environment 124, and the customer devices 122. In at least some examples, both the monitoring center environment 120 and the data center environment 124 include network equipment (e.g., similar to the router 116) that is configured to communicate with the network 118 and computing devices collocated with or near the network equipment. It should be noted that, in some examples, the network 118 and the network extant within the monitored location 102A support other communication protocols, such as MQTT or other IoT protocols.

The data center environment 124 can include physical space, communications, cooling, and power infrastructure to support networked operation of computing devices. For instance, this infrastructure can include rack space into which the computing devices are installed, uninterruptible power supplies, cooling plenum and equipment, and networking devices. The data center environment 124 can be dedicated to the security system 100, can be a non-dedicated, commercially available cloud computing service (e.g., MICROSOFT AZURE, AMAZON WEB SERVICES, GOOGLE CLOUD, or the like), or can include a hybrid configuration made up of dedicated and non-dedicated resources. Regardless of its physical or logical configuration, as shown in FIG. 1, the data center environment 124 is configured to host the surveillance service 128 and the transport services 126.

In some examples, the monitoring center environment 120 can include a plurality of computing devices (e.g., desktop computers) and network equipment (e.g., one or more routers) connected to the computing devices and the network 118. The customer devices 122 can include personal computing devices (e.g., a desktop computer, laptop, tablet, smartphone, or the like) and network equipment (e.g., a router, cellular modem, cellular radio, or the like). As illustrated in FIG. 1, the monitoring center environment 120 is configured to host the monitor interfaces 130 and the customer devices 122 are configured to host the customer interfaces 132.

Continuing with the example of FIG. 1, the devices 106, 110, and 112 are configured to acquire analog signals via sensors incorporated into the devices, generate digital sensor data based on the acquired signals, and communicate (e.g. via a wireless link with the router 116) the sensor data to the base station 114. The type of sensor data generated and communicated by these devices varies along with the type of sensors included in the devices. For instance, the image capture devices 110 can acquire ambient light, generate frames of image data based on the acquired light, and communicate the frames to the base station 114, the monitor interfaces 130, and/or the customer interfaces 132, although the pixel resolution and frame rate may vary depending on the capabilities of the devices. Where the image capture devices 110 have sufficient processing capacity and available power, the image capture devices 110 can process the image frames and transmit messages based on content depicted in the image frames, as described further below. These messages may specify reportable events and may be transmitted in place of, or in addition to, the image frames. Such messages may be sent directly to another location-based device (e.g., via sub-GHz networking) and/or indirectly to any device within the system 100 (e.g., via the router 116). As shown in FIG. 1, the image capture device 100a has a field of view (FOV) that originates proximal to a front door of the location 102A and can acquire images of a walkway, highway, and a space between the location 102A and the highway. The image capture device 110b has an FOV that originates proximal to a bathroom of the location 102A and can acquire images of a living room and dining area of the location 102A. The image capture device 110b can further acquire images of outdoor areas beyond the location 102A through windows 104A and 104B on the right side of the location 102A.

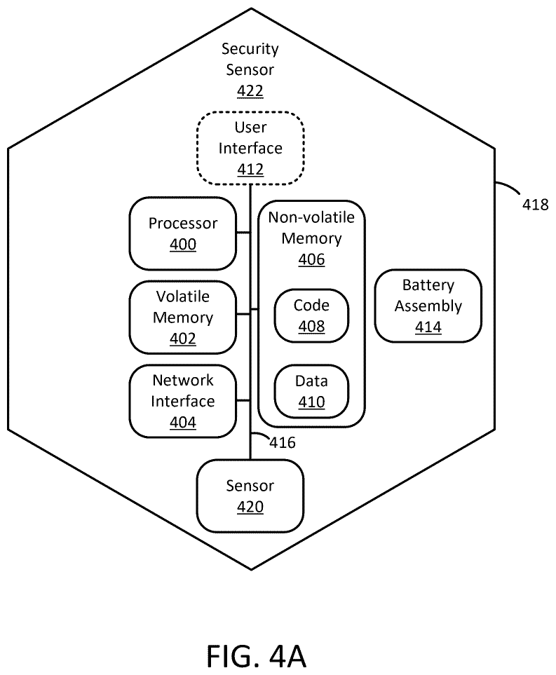

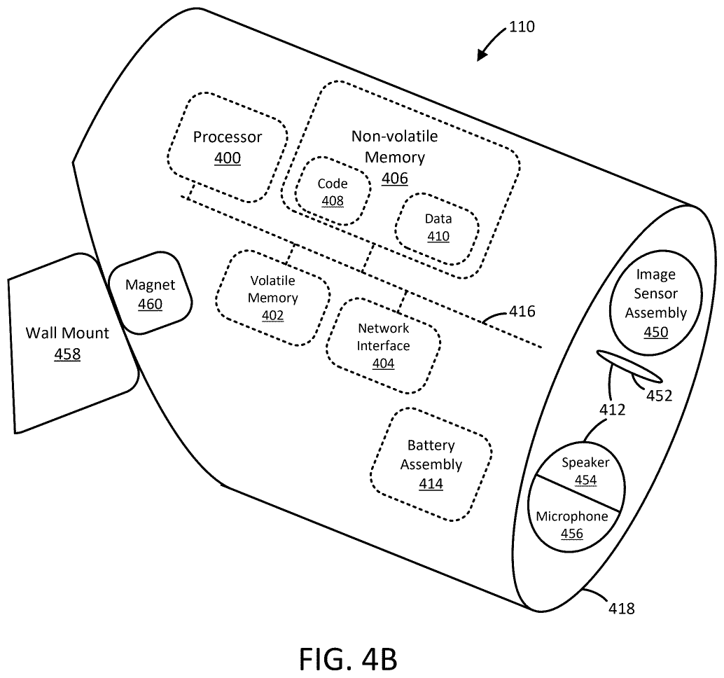

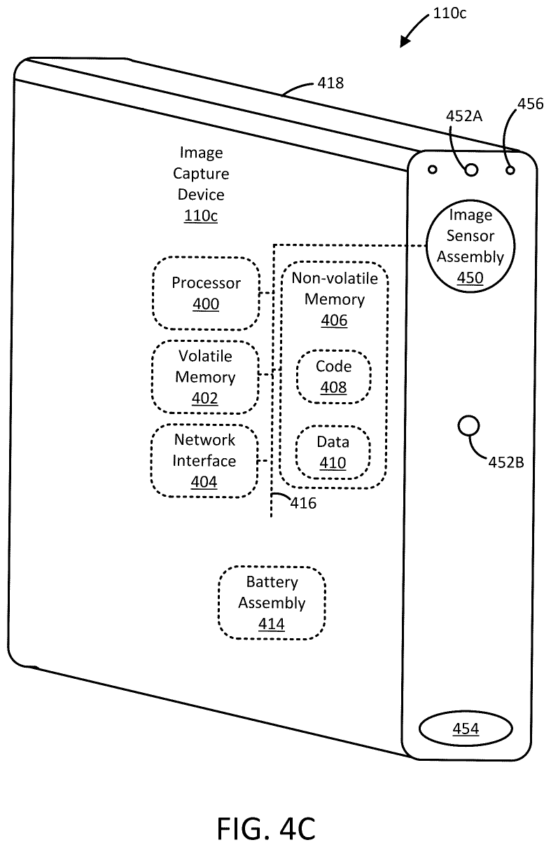

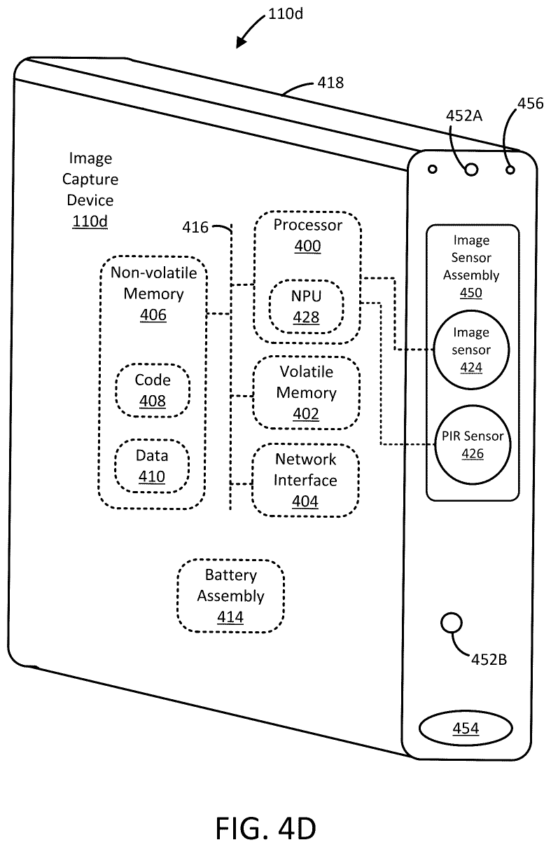

Further, as shown in FIG. 1, in some examples the image capture device 110 is configured to communicate with the surveillance service 128, the monitor interfaces 130, and the customer interfaces 132 separately from the surveillance client 136 via execution of the camera agent 138. These communications can include sensor data generated by the image capture device 110 and/or commands to be executed by the image capture device 110 sent by the surveillance service 128, the monitor interfaces 130, and/or the customer interfaces 132. The commands can include, for example, requests for interactive communication sessions in which monitoring personnel and/or customers interact with the image capture device 110 via the monitor interfaces 130 and the customer interfaces 132. These interactions can include requests for the image capture device 110 to transmit additional sensor data and/or requests for the image capture device 110 to render output via a user interface (e.g., the user interface 412 of FIGS. 4B and 4C). This output can include audio and/or video output.

Continuing with the example of FIG. 1, the contact sensor assembly 106 includes a sensor that can detect the presence or absence of a magnetic field generated by a magnet when the magnet is proximal to the sensor. When the magnetic field is present, the contact sensor assembly 106 generates Boolean sensor data specifying a closed state. When the magnetic field is absent, the contact sensor assembly 106 generates Boolean sensor data specifying an open state. In either case, the contact sensor assembly 106 can communicate, to the base station 114, sensor data indicating whether the front door of the location 102A is open or closed. The motion sensor assembly 112 can include an audio emission device that can radiate sound (e.g., ultrasonic) waves and an audio sensor that can acquire reflections of the waves. When the audio sensor detects the reflection because no objects are in motion within the space monitored by the audio sensor, the motion sensor assembly 112 generates Boolean sensor data specifying a still state. When the audio sensor does not detect a reflection because an object is in motion within the monitored space, the motion sensor assembly 112 generates Boolean sensor data specifying an alarm state. In either case, the motion sensor assembly 112 can communicate the sensor data to the base station 114. It should be noted that the specific sensing modalities described above are not limiting to the present disclosure. For instance, as one of many potential examples, the motion sensor assembly 112 can base its operation on acquisition of sensor data indicating changes in temperature rather than changes in reflected sound waves.

In some examples, the keypad 108 is configured to interact with a user and interoperate with the other location-based devices in response to interactions with the user. For instance, in some examples, the keypad 108 is configured to receive input from a user that specifies one or more commands and to communicate the specified commands to one or more addressed processes. These addressed processes can include processes implemented by one or more of the location-based devices and/or one or more of the monitor interfaces 130 or the surveillance service 128. The commands can include, for example, codes that authenticate the user as a resident of the location 102A and/or codes that request activation or deactivation of one or more of the location-based devices. Alternatively or additionally, in some examples, the keypad 108 includes a user interface (e.g., a tactile interface, such as a set of physical buttons or a set of virtual buttons on a touchscreen) configured to interact with a user (e.g., receive input from and/or render output to the user). Further still, in some examples, the keypad 108 can receive and respond to the communicated commands and render the responses via the user interface as visual or audio output.

Continuing with the example of FIG. 1, the base station 114 is configured to interoperate with the other location-based devices to provide local command and control and store-and-forward functionality via execution of the surveillance client 136. In some examples, to implement store-and-forward functionality, the base station 114, through execution of the surveillance client 136, receives sensor data, packages the data for transport, and stores the packaged sensor data in local memory for subsequent communication. This communication of the packaged sensor data can include, for instance, transmission of the packaged sensor data as a payload of a message to one or more of the transport services 126 when a communication link to the transport services 126 via the network 118 is operational. In some examples, packaging the sensor data can include filtering the sensor data and/or generating one or more summaries (maximum values, minimum values, average values, changes in values since the previous communication of the same, etc.) of multiple sensor readings. To implement local command and control functionality, the base station 114 executes, under control of the surveillance client 136, a variety of programmatic operations in response to various events. Examples of these events can include reception of commands from the keypad 108, reception of commands from one of the monitor interfaces 130 or the customer interface application 132 via the network 118, or detection of the occurrence of a scheduled event. The programmatic operations executed by the base station 114 under control of the surveillance client 136 can include activation or deactivation of one or more of the devices 106, 108, 110, and 112; sounding of an alarm; reporting an event to the surveillance service 128; and communicating location data to one or more of the transport services 126 to name a few operations. The location data can include data specifying sensor readings (sensor data), configuration data of any of the location-based devices, commands input and received from a user (e.g., via the keypad 108 or a customer interface 132), or data derived from one or more of these data types (e.g., filtered sensor data, summarizations of sensor data, event data specifying an event detected at the location via the sensor data, etc.).

Continuing with the example of FIG. 1, the transport services 126 are configured to securely, reliably, and efficiently exchange messages between processes implemented by the location-based devices and processes implemented by other devices in the system 100. These other devices can include the customer devices 122, devices disposed in the data center environment 124, and/or devices disposed in the monitoring center environment 120. In some examples, the transport services 126 are also configured to parse messages from the location-based devices to extract payloads included therein and store the payloads and/or data derived from the payloads within one or more data stores hosted in the data center environment 124. The data housed in these data stores may be subsequently accessed by, for example, the surveillance service 128, the monitor interfaces 130, and the customer interfaces 132.

In certain examples, the transport services 126 expose and implement one or more application programming interfaces (APIs) that are configured to receive, process, and respond to calls from processes (e.g., the surveillance client 136) implemented by base stations (e.g., the base station 114) and/or processes (e.g., the camera agent 138) implemented by other devices (e.g., the image capture device 110). Individual instances of a transport service within the transport services 126 can be associated with and specific to certain manufactures and models of location-based monitoring equipment (e.g., SIMPLISAFE equipment, RING equipment, etc.). The APIs can be implemented using a variety of architectural styles and interoperability standards. For instance, in one example, the API is a web services interface implemented using a representational state transfer (REST) architectural style. In this example, API calls are encoded in Hypertext Transfer Protocol (HTTP) along with JavaScript Object Notation (JSON) and/or extensible markup language (XML). These API calls are addressed to one or more uniform resource locators (URLs) that are API endpoints monitored by the transport services 126. In some examples, portions of the HTTP communications are encrypted to increase security. Alternatively or additionally, in some examples, the API is implemented as an MQTT broker that receives messages and transmits responsive messages to MQTT clients hosted by the base stations and/or the other devices. Alternatively or additionally, in some examples, the API is implemented using simple file transfer protocol commands. Thus, the transport services 126 are not limited to a particular protocol or architectural style. It should be noted that, in at least some examples, the transport services 126 can transmit one or more API calls to location-based devices to request data from, or an interactive communication session with, the location-based devices.

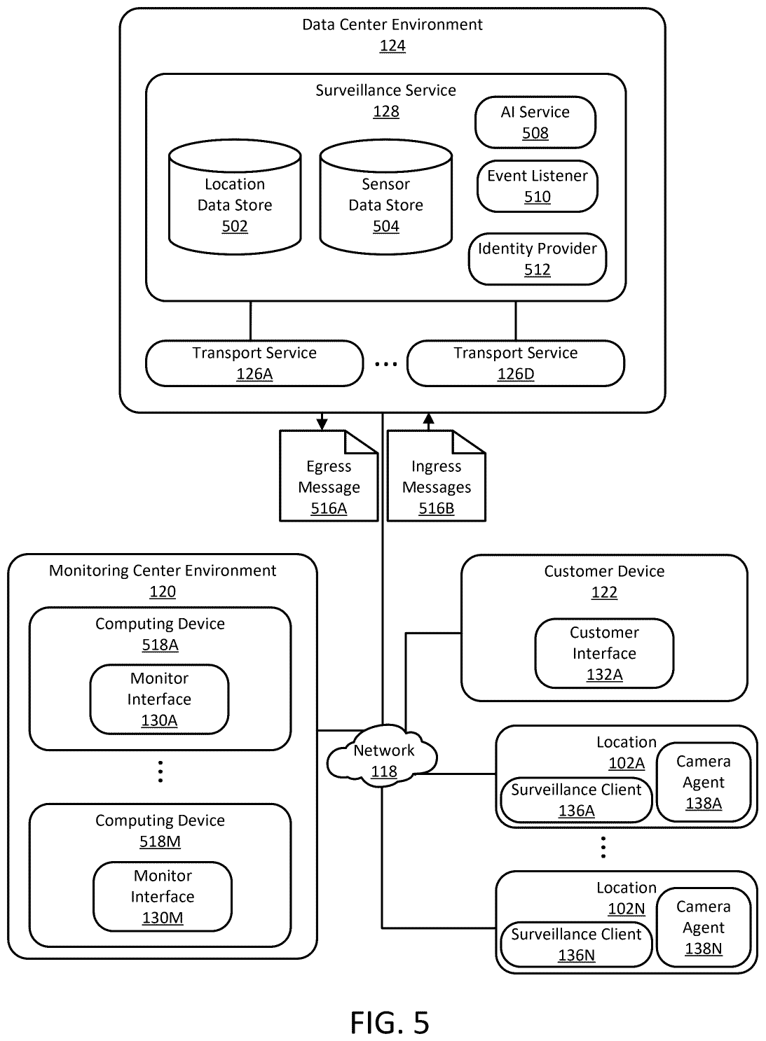

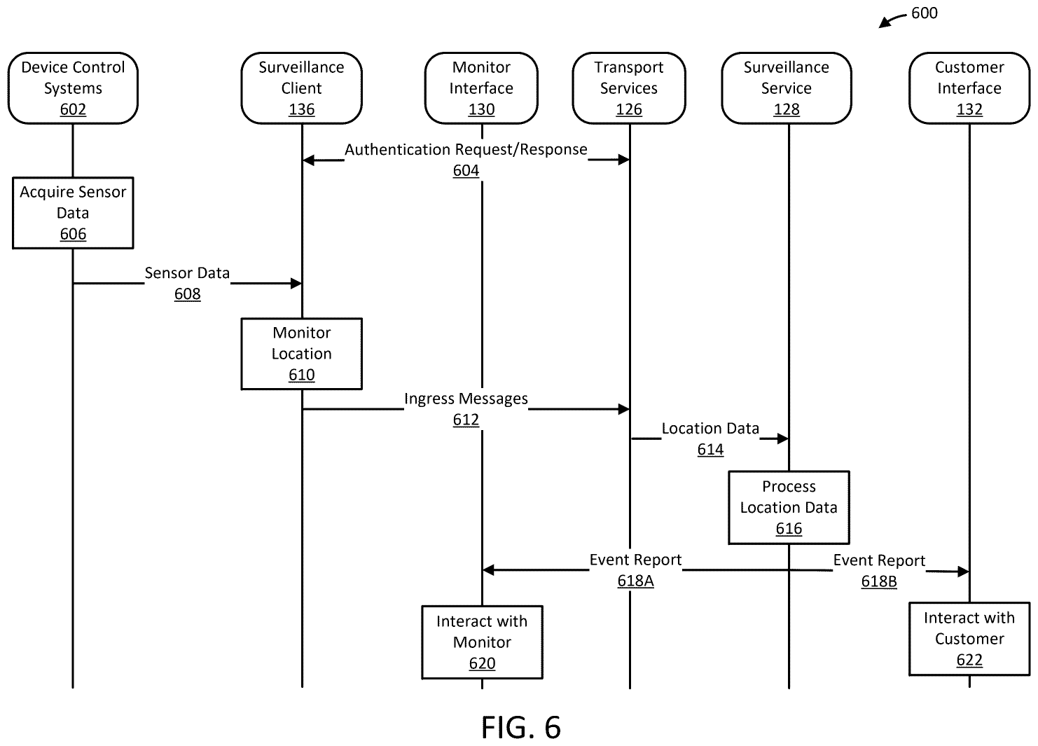

Continuing with the example of FIG. 1, the surveillance service 128 is configured to control overall logical setup and operation of the system 100. As such, the surveillance service 128 can interoperate with the transport services 126, the monitor interfaces 130, the customer interfaces 132, and any of the location-based devices. In some examples, the surveillance service 128 is configured to monitor data from a variety of sources for reportable events (e.g., a break-in event or other event flagged for handling, e.g., by a monitoring professional) and, when a reportable event is detected, notify one or more of the monitor interfaces 130 and/or the customer interfaces 132 of the reportable event. In some examples, the surveillance service 128 is also configured to maintain state information regarding the location 102A. This state information can indicate, for instance, whether the location 102A is safe or under threat. In certain examples, the surveillance service 128 is configured to change the state information to indicate that the location 102A is safe only upon receipt of a communication indicating a clear event (e.g., rather than making such a change in response to discontinuation of reception of break-in events). This aspect can prevent a “crash and smash” robbery from being successfully executed. Further example processes that the surveillance service 128 is configured to execute are described below with reference to FIGS. 5 and 6.

In some examples, individual monitor interfaces 130 are configured to control computing device interaction with monitoring personnel and to execute a variety of programmatic operations in response to the interactions. For instance, in some examples, the monitor interface 130 controls its host device to provide information regarding reportable events detected at monitored locations, such as the location 102A, to monitoring personnel. Such events can include, for example, movement or an alarm condition generated by one or more of the location-based devices. Alternatively or additionally, in some examples, the monitor interface 130 controls its host device to interact with a user to configure aspects of the system 100. Further example processes that the monitor interface 130 is configured to execute are described below with reference to FIG. 6. It should be noted that, in at least some examples, the monitor interfaces 130 are browser-based applications served to the monitoring center environment 120 by webservers included within the data center environment 124. These webservers may be part of the surveillance service 128, in certain examples.

Continuing with the example of FIG. 1, individual customer interfaces 132 are configured to control computing device interaction with a customer and to execute a variety of programmatic operations in response to the interactions. For instance, in some examples, the customer interface 132 controls its host device to provide information regarding reportable events detected at monitored locations, such as the location 102A, to the customer. Such events can include, for example, an alarm condition generated by one or more of the location-based devices. Alternatively or additionally, in some examples, the customer interface 132 is configured to process input received from the customer to activate or deactivate one or more of the location-based devices. Further still, in some examples, the customer interface 132 configures aspects of the system 100 in response to input from a user. Further example processes that the customer interface 132 is configured to execute are described below with reference to FIG. 6.

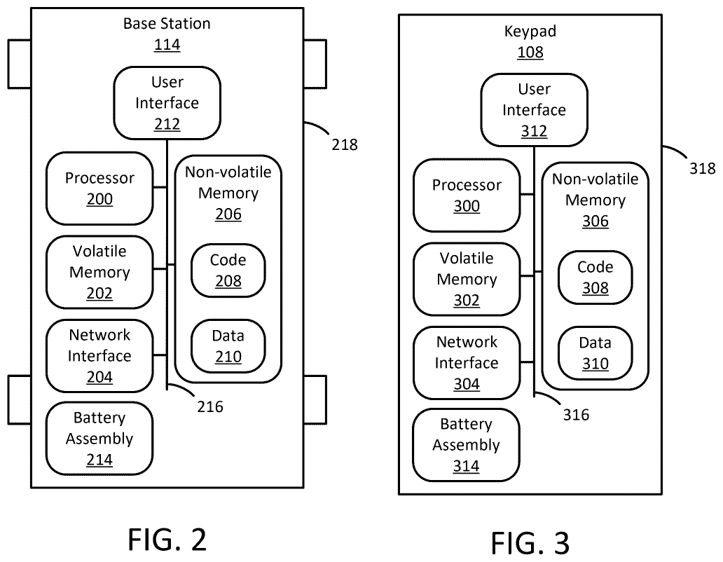

Turning now to FIG. 2, an example of a base station 114 is schematically illustrated. As shown in FIG. 2, the base station 114 includes at least one processor 200, volatile memory 202, non-volatile memory 206, at least one network interface 204, a user interface 212, a battery assembly 214, and an interconnection mechanism 216. The non-volatile memory 206 stores executable code 208 and includes a data store 210. In some examples illustrated by FIG. 2, the components of the base station 114 enumerated above are incorporated within, or are a part of, a housing 218.

In some examples, the non-volatile (non-transitory) memory 206 includes one or more read-only memory (ROM) chips; one or more hard disk drives or other magnetic or optical storage media; one or more solid state drives (SSDs), such as a flash drive or other solid-state storage media; and/or one or more hybrid magnetic and SSDs. In certain examples, the code 208 stored in the non-volatile memory can include an operating system and one or more applications or programs that are configured to execute under the operating system. Alternatively or additionally, the code 208 can include specialized firmware and embedded software that is executable without dependence upon a commercially available operating system. Regardless, execution of the code 208 can implement the surveillance client 136 of FIG. 1 and can result in manipulated data that is a part of the data store 210.

Continuing with the example of FIG. 2, the processor 200 can include one or more programmable processors to execute one or more executable instructions, such as a computer program specified by the code 208, to control the operations of the base station 114. As used herein, the term “processor” describes circuitry that executes a function, an operation, or a sequence of operations. The function, operation, or sequence of operations can be hard coded into the circuitry or soft coded by way of instructions held in a memory device (e.g., the volatile memory 202) and executed by the circuitry. In some examples, the processor 200 is a digital processor, but the processor 200 can be analog, digital, or mixed. As such, the processor 200 can execute the function, operation, or sequence of operations using digital values and/or using analog signals. In some examples, the processor 200 can be embodied in one or more application specific integrated circuits (ASICs), microprocessors, digital signal processors (DSPs), graphics processing units (GPUs), neural processing units (NPUs), microcontrollers, field programmable gate arrays (FPGAs), programmable logic arrays (PLAs), or multicore processors. Examples of the processor 200 that are multicore can provide functionality for parallel, simultaneous execution of instructions or for parallel, simultaneous execution of one instruction on more than one piece of data.

Continuing with the example of FIG. 2, prior to execution of the code 208 the processor 200 can copy the code 208 from the non-volatile memory 206 to the volatile memory 202. In some examples, the volatile memory 202 includes one or more static or dynamic random access memory (RAM) chips and/or cache memory (e.g. memory disposed on a silicon die of the processor 200). Volatile memory 202 can offer a faster response time than a main memory, such as the non-volatile memory 206.

Through execution of the code 208, the processor 200 can control operation of the network interface 204. For instance, in some examples, the network interface 204 includes one or more physical interfaces (e.g., a radio, an ethernet port, a universal serial bus (USB) port, etc.) and a software stack including drivers and/or other code 208 that is configured to communicate with the one or more physical interfaces to support one or more LAN, PAN, and/or WAN standard communication protocols. The communication protocols can include, for example, transmission control protocol (TCP), user datagram protocol (UDP), HTTP, and MQTT among others. As such, the network interface 204 enables the base station 114 to access and communicate with other computing devices (e.g., the location-based devices) via a computer network (e.g., the LAN established by the router 116 of FIG. 1, the network 118 of FIG. 1, and/or a point-to-point connection). For instance, in at least one example, the network interface 204 utilizes sub-GHz wireless networking to transmit messages to other location-based devices. These messages can include wake messages to request streams of sensor data, alarm messages to trigger alarm responses, or other messages to initiate other operations. Bands that the network interface 204 may utilize for sub-GHz wireless networking include, for example, an 868 MHz band and/or a 915 MHz band. Use of sub-GHz wireless networking can improve operable communication distances and/or reduce power consumed to communicate.

Through execution of the code 208, the processor 200 can control operation of the user interface 212. For instance, in some examples, the user interface 212 includes user input and/or output devices (e.g., a keyboard, a mouse, a touchscreen, a display, a speaker, a camera, an accelerometer, a biometric scanner, an environmental sensor, etc.) and a software stack including drivers and/or other code 208 that is configured to communicate with the user input and/or output devices. For instance, the user interface 212 can be implemented by a customer device 122 hosting a mobile application (e.g., a customer interface 132). The user interface 212 enables the base station 114 to interact with users to receive input and/or render output. This rendered output can include, for instance, one or more GUIs including one or more controls configured to display output and/or receive input. The input can specify values to be stored in the data store 210. The output can indicate values stored in the data store 210. It should be noted that, in some examples, parts of the user interface 212 are accessible and/or visible as part of, or through, the housing 218. These parts of the user interface 212 can include, for example, one or more light-emitting diodes (LEDs). Alternatively or additionally, in some examples, the user interface 212 includes a 95 dB siren that the processor 200 sounds to indicate that a break-in event has been detected.

Continuing with the example of FIG. 2, the various components of the base station 114 described above can communicate with one another via the interconnection mechanism 216. In some examples, the interconnection mechanism 216 includes a communications bus. In addition, in some examples, the battery assembly 214 is configured to supply operational power to the various components of the base station 114 described above. In some examples, the battery assembly 214 includes at least one rechargeable battery (e.g., one or more NiMH or lithium batteries). In some examples, the rechargeable battery has a runtime capacity sufficient to operate the base station 114 for 24 hours or longer while the base station 114 is disconnected from or otherwise not receiving line power. Alternatively or additionally, in some examples, the battery assembly 214 includes power supply circuitry to receive, condition, and distribute line power to both operate the base station 114 and recharge the rechargeable battery. The power supply circuitry can include, for example, a transformer and a rectifier, among other circuitry, to convert AC line power to DC device and recharging power.

Turning now to FIG. 3, an example keypad 108 is schematically illustrated. As shown in FIG. 3, the keypad 108 includes at least one processor 300, volatile memory 302, non-volatile memory 306, at least one network interface 304, a user interface 312, a battery assembly 314, and an interconnection mechanism 316. The non-volatile memory 306 stores executable code 308 and a data store 310. In some examples illustrated by FIG. 3, the components of the keypad 108 enumerated above are incorporated within, or are a part of, a housing 318.

In some examples, the respective descriptions of the processor 200, the volatile memory 202, the non-volatile memory 206, the interconnection mechanism 216, and the battery assembly 214 with reference to the base station 114 are applicable to the processor 300, the volatile memory 302, the non-volatile memory 306, the interconnection mechanism 316, and the battery assembly 314, respectively, with reference to the keypad 108. As such, those descriptions will not be repeated.

Continuing with the example of FIG. 3, through execution of the code 308, the processor 300 can control operation of the network interface 304. In some examples, the network interface 304 includes one or more physical interfaces (e.g., a radio, an ethernet port, a USB port, etc.) and a software stack including drivers and/or other code 308 that is configured to communicate with the one or more physical interfaces to support one or more LAN, PAN, and/or WAN standard communication protocols. These communication protocols can include, for example, TCP, UDP, HTTP, and MQTT among others. As such, the network interface 304 enables the keypad 108 to access and communicate with other computing devices (e.g., the other location-based devices) via a computer network (e.g., the LAN established by the router 116 and/or a point-to-point connection).

Continuing with the example of FIG. 3, through execution of the code 308, the processor 300 can control operation of the user interface 312. In some examples, the user interface 312 includes user input and/or output devices (e.g., physical keys arranged as a keypad, a touchscreen, a display, a speaker, a camera, a biometric scanner, an environmental sensor, etc.) and a software stack including drivers and/or other code 308 that is configured to communicate with the user input and/or output devices. As such, the user interface 312 enables the keypad 108 to interact with users to receive input and/or render output. This rendered output can include, for instance, one or more GUIs including one or more controls configured to display output and/or receive input. The input can specify values to be stored in the data store 310. The output can indicate values stored in the data store 310. It should be noted that, in some examples, parts of the user interface 312 (e.g., one or more LEDs) are accessible and/or visible as part of, or through, the housing 318.

In some examples, devices like the keypad 108, which rely on user input to trigger an alarm condition, may be included within a security system, such as the security system 100 of FIG. 1. Examples of such devices include dedicated key fobs and panic buttons. These dedicated security devices provide a user with a simple, direct way to trigger an alarm condition, which can be particularly helpful in times of duress.

Turning now to FIG. 4A, an example of a security sensor 422 is schematically illustrated. Particular configurations of the security sensor 422 (e.g., the image capture device 110, the motion sensor assembly 112, and the contact sensor assemblies 106) are illustrated in FIG. 1 and described above. Other examples of security sensors 422 include glass break sensors, carbon monoxide sensors, smoke detectors, water sensors, temperature sensors, and door lock sensors, to name a few. As shown in FIG. 4A, the security sensor 422 includes at least one processor 400, volatile memory 402, non-volatile memory 406, at least one network interface 404, a battery assembly 414, an interconnection mechanism 416, and at least one sensor assembly 420. The non-volatile memory 406 stores executable code 408 and a data store 410. Some examples include a user interface 412. In certain examples illustrated by FIG. 4A, the components of the security sensor 422 enumerated above are incorporated within, or are a part of, a housing 418.

In some examples, the respective descriptions of the processor 200, the volatile memory 202, the non-volatile memory 206, the interconnection mechanism 216, and the battery assembly 214 with reference to the base station 114 are applicable to the processor 400, the volatile memory 402, the non-volatile memory 406, the interconnection mechanism 416, and the battery assembly 414, respectively, with reference to the security sensor 422. As such, those descriptions will not be repeated.

Continuing with the example of FIG. 4A, through execution of the code 408, the processor 400 can control operation of the network interface 404. In some examples, the network interface 404 includes one or more physical interfaces (e.g., a radio (including an antenna), an ethernet port, a USB port, etc.) and a software stack including drivers and/or other code 408 that is configured to communicate with the one or more physical interfaces to support one or more LAN, PAN, and/or WAN standard communication protocols. The communication protocols can include, for example, TCP, UDP, HTTP, and MQTT among others. As such, the network interface 404 enables the security sensor 422 to access and communicate with other computing devices (e.g., the other location-based devices) via a computer network (e.g., the LAN established by the router 116 and/or a point-to-point connection). For instance, in at least one example, when executing the code 408, the processor 400 controls the network interface to stream (e.g., via UDP) sensor data acquired from the sensor assembly 420 to the base station 114. Alternatively or additionally, in at least one example, through execution of the code 408, the processor 400 can control the network interface 404 to enter a power conservation mode by powering down a 2.4 GHz radio and powering up a sub-GHz radio that are both included in the network interface 404. In this example, through execution of the code 408, the processor 400 can control the network interface 404 to enter a streaming or interactive mode by powering up a 2.4 GHz radio and powering down a sub-GHz radio, for example, in response to receiving a wake signal from the base station via the sub-GHz radio.

Continuing with the example of FIG. 4A, through execution of the code 408, the processor 400 can control operation of the user interface 412. In some examples, the user interface 412 includes user input and/or output devices (e.g., physical buttons, a touchscreen, a display, a speaker, a camera, an accelerometer, a biometric scanner, an environmental sensor, one or more LEDs, etc.) and a software stack including drivers and/or other code 408 that is configured to communicate with the user input and/or output devices. As such, the user interface 412 enables the security sensor 422 to interact with users to receive input and/or render output. This rendered output can include, for instance, one or more GUIs including one or more controls configured to display output and/or receive input. The input can specify values to be stored in the data store 410. The output can indicate values stored in the data store 410. It should be noted that, in some examples, parts of the user interface 412 are accessible and/or visible as part of, or through, the housing 418.

The sensor assembly 420 can include one or more types of sensors, such as the sensors described above with reference to the image capture devices 110, the motion sensor assembly 112, and the contact sensor assembly 106 of FIG. 1, or other types of sensors. For instance, in at least one example, the sensor assembly 420 includes an image sensor (e.g., a charge-coupled device or an active-pixel sensor) and a temperature or thermographic sensor (e.g., an active and/or passive infrared (PIR) sensor). Regardless of the type of sensor or sensors housed, the processor 400 can (e.g., via execution of the code 408) acquire sensor data from the housed sensor and stream the acquired sensor data to the processor 400 for communication to the base station.

It should be noted that, in some examples of the devices 108 and 422, the operations executed by the processors 300 and 400 while under control of respective control of the code 308 and 408 may be hardcoded and/or implemented in hardware, rather than as a combination of hardware and software. Moreover, execution of the code 408 can implement the camera agent 138 of FIG. 1 and can result in manipulated data that is a part of the data store 410.

Turning now to FIG. 4B, an example of the image capture device 110 is schematically illustrated. As shown in FIG. 4B, in some examples, the image capture device 110 includes at least one processor 400, volatile memory 402, non-volatile memory 406, at least one network interface 404, a battery assembly 414, and an interconnection mechanism 416. These components of the image capture device 110 are illustrated in dashed lines to indicate that they reside within a housing 418. The non-volatile memory 406 stores executable code 408 and a data store 410.

Some examples further include an image sensor assembly 450, which may be an example of the sensor assembly 420. Some examples further include a light source 452, a speaker 454, a microphone 456, a wall mount 458, and a magnet 460. The image sensor assembly 450 may include a lens and an image sensor (e.g., a charge-coupled device or an active-pixel sensor) and/or a temperature or thermographic sensor (e.g., an active and/or passive infrared (PIR) sensor). The light source 452 may include a light emitting diode (LED), such as a red-green-blue emitting LED. The light source 452 may also include an infrared emitting diode in some examples. The speaker 454 may include a transducer configured to emit sound in the range of 60 dB to 80 dB or louder. Further, in some examples, the speaker 454 can include a siren configured to emit sound in the range of 70 dB to 90 dB or louder. The microphone 456 may include a micro electro-mechanical system (MEMS) microphone. The wall mount 458 may include a mounting bracket, configured to accept screws or other fasteners that adhere the bracket to a wall, and a cover configured to mechanically couple to the mounting bracket. In some examples, the cover is composed of a magnetic material, such as aluminum or stainless steel, to enable the magnet 460 to magnetically couple to the wall mount 458, thereby holding the image capture device 110 in place.

In some examples, the respective descriptions of the processor 400, the volatile memory 402, the network interface 404, the non-volatile memory 406, the code 408 with respect to the network interface 404, the interconnection mechanism 416, and the battery assembly 414 with reference to the security sensor 422 are applicable to these same components with reference to the image capture device 110. As such, those descriptions will not be repeated here.

Continuing with the example of FIG. 4B, through execution of the code 408, the processor 400 can control operation of the image sensor assembly 450, the light source 452, the speaker 454, and the microphone 456. For instance, in at least one example, when executing the code 408, the processor 400 controls the image sensor assembly 450 to acquire sensor data, in the form of image data, to be streamed to the base station 114 (or one of the processes 130, 128, or 132 of FIG. 1) via the network interface 404. Alternatively or additionally, in at least one example, through execution of the code 408, the processor 400 controls the light source 452 to emit light so that the image sensor assembly 450 collects sufficient reflected light to compose the image data. Further, in some examples, through execution of the code 408, the processor 400 controls the speaker 454 to emit sound. This sound may be locally generated (e.g., a sonic alarm via the siren) or streamed from the base station 114 (or one of the processes 130, 128 or 132 of FIG. 1) via the network interface 404 (e.g., utterances from the user or monitoring personnel). Further still, in some examples, through execution of the code 408, the processor 400 controls the microphone 456 to acquire sensor data in the form of sound for streaming to the base station 114 (or one of the processes 130, 128 or 132 of FIG. 1) via the network interface 404.

In the example of FIG. 4B, the speaker 454, and the microphone 456 implement an instance of the user interface 412 of FIG. 4A. Further, the image sensor assembly 450, optionally together with the light source 452, implement an instance of the sensor assembly 420 of FIG. 4A. As such, the image capture device 110 illustrated in FIG. 4B is at least one example of the security sensor 422 illustrated in FIG. 4A. The image capture device 110 may be a battery-powered outdoor sensor configured to be installed and operated in an outdoor environment, such as outside a home, office, store, or other commercial or residential building, for example. The image capture device 110 may instantiate the image capture devices 110a and/or 110b illustrated in FIG. 1. It will further be appreciated that in some applications, the image capture device 110 need not serve a security function and/or may be part of a smart home system or device that is not part of a security system. Accordingly, examples and aspects of the image capture device 110 described herein are not limited to security systems and/or security applications.

Turning now to FIG. 4C, another example of an image capture device 110c is schematically illustrated. The image capture device 110c is a variation of the image capture device 110 and may be used as the image capture devices 110a and/or 110b illustrated in FIG. 1, for example. As shown in FIG. 4C, the image capture device 110c includes the at least one processor 400, volatile memory 402, non-volatile memory 406, the at least one network interface 404, the battery assembly 414, and the interconnection mechanism 416. These components of the image capture device 110c are illustrated in dashed lines to indicate that they reside within a housing 418. As described above, the non-volatile memory 406 stores executable code 408 and a data store 410. The image capture device 110c further includes the image sensor assembly 450, the speaker 454, and the microphone 456 as described above with reference to the image capture device 110 of FIG. 4B. As illustrated in FIG. 4C, the image sensor assembly 450 may be coupled to the processor 400 (e.g., to allow for processing of images acquired by the image sensor assembly) and/or to the network interface 404 (e.g., to allow for transmission of images captured by the image sensor assembly) via the interconnection mechanism 416. Although not illustrated in FIG. 4C, it will be appreciated that the speaker 454 and/or the microphone 456 may also be coupled to the processor 400 via the interconnection mechanism 416, for example.

In some examples, the image capture device 110c further includes light sources 452A and 452B. The light source 452A may include a light emitting diode (LED), such as a red-green-blue emitting LED. The light source 452B may also include an infrared emitting diode to enable night vision in some examples. The light sources 452A and 452B are examples of the light source 452 of FIG. 4B.

In the example of FIG. 4C, the speaker 454, and the microphone 456 implement an instance of the user interface 412 of FIG. 4A. In some examples, the image sensor assembly 450, optionally in combination with one or both of the light sources 452A, 452B, implements an instance of the sensor assembly 420 of FIG. 4A. As such, the image capture device 110c illustrated in FIG. 4C is at least one example of the security sensor 422 illustrated in FIG. 4A. The image capture device 110c may be a battery-powered indoor sensor configured to be installed and operated in an indoor environment, such as within a home, office, store, or other commercial or residential building, for example.

FIG. 4D illustrates another example of an image capture device 110d. The image capture device 110d is another variation or example of the image capture device 110 and may be used as the image capture devices 110a and/or 110b illustrated in FIG. 1, for example. In this example, the image sensor assembly 450 includes one or more image sensors 424 (e.g., imaging sensors configured to capture images in one or more spectral bands of the electromagnetic spectrum) and one or more PIR sensors 426, as described above. In some examples, the image sensor 424 collects still image frames and/or video image frames constituting a video feed/stream. The image sensor 424 may operate in the visible spectral band and/or the infrared spectral band, for example. As shown in FIG. 4D, the image sensor 424 and the PIR sensor 426 are coupled to the processor 400, for example, via the interconnection mechanism 416.

In one example, the PIR sensor 426 operates as a motion detector. PIR sensors are motion sensors that detect changes in temperature over a pre-determined field of view. The PIR sensor 426 can be configured with a threshold such that any change larger than the threshold constitutes motion and causes the image capture device 110d to take some further action, such as issuing an alert and/or communicating information to the base station 114. In some examples, the PIR sensor 426 can be tuned to detect people and/or animals based on a known temperature range associated with the body temperatures of people and/or animals.

According to certain examples, the image capture device 110d operates in a low power state (operating mode) in which the image sensor 424 (and optionally other components of the image capture device 110d, such as the light source 452, for example) are deactivated, until motion is detected by the PIR sensor 426. Thus, in some examples, in the low power operating mode, the PIR sensor 426 remains active, but components that generally consume more power, such as the image sensor 424, for example, are powered off. In the low power operating mode, the processor 400 may perform minimal processing, sufficient to monitor for events that trigger the PIR sensor 426. When the PIR sensor 426 indicates motion and issues a signal or notification (e.g., sends a motion trigger signal to the processor 400), the processor 400 is placed into a normal operating mode, in which the image sensor 424 (along with any other components of the image capture device 110d that are powered off in the low power mode) is enabled. Thus, the PIR sensor 426 can act as a mode “switch” that configures the image capture device 110d into the “full power” or normal operating mode only when necessary. In this manner, power can be conserved by operating the image capture device 110d in the low power mode, with various components powered off, until a potential event of interest is detected.

Once active, the image sensor 424 captures one or more frames of image data. In some examples, the image sensor 424 passes the frame(s) of image data (“images” or “image frames”) to the processor 400 for processing. In examples, the processor 400 applies a motion detection process to the captured image frames to detect moving objects, which may then be identified as either objects of interest (e.g., people), detection of which may cause the image capture device 110d to issue an alert, or benign objects that can be safely ignored.

Still referring to FIG. 4D, in some examples, the processor 400 includes a neural processing unit (NPU) 428 for efficiently running neural networks to perform aspects of a motion detection process based on the image frames captured by the image sensor 424. In examples, the image capture device 110d is capable of detecting, and distinguishing between, certain objects, such as people or pets, for example, in the image frames captured by the image sensor 424, and can be configured to communicate an object detection event if an object of interest is identified. The image capture device 110d can use any of a variety of techniques to locate and recognize objects in an image frame. For example, computer vision based object detection can use specialized filters for locating different attributes or features within an image frame and then combining the features to classify whether or not a particular category of object is found. For example, an object detector can locate all human faces in a frame. In some examples, the NPU 428 can be configured to implement machine learning based processes or models that are trained on a vast number of images containing objects of interest to recognize similar objects in new or previously unseen images. In addition, examples of the image capture device 110d are configured to detect motion relative to recognized objects. Motion detection is the process of detecting a change in position of an object relative to its surroundings or the change in the surroundings relative to an object. As described above, motion detection based on image processing can be performed by computing the pixel-to-pixel difference in intensity between consecutive frames to create a “difference image” and then applying a threshold to the difference image. In certain examples, any difference values larger than the threshold constitute motion.

In some examples, some or all of the image processing described above may be performed by the processor 400. In some examples, the image capture device 110 can transmit (e.g., via the network interface 404) processed and/or unprocessed images, or summaries thereof, from the image sensor assembly 450 to a remote device for (further) processing and/or analysis.

Turning now to FIG. 5, aspects of the data center environment 124 of FIG. 1, the monitoring center environment 120 of FIG. 1, one of the customer devices 122 of FIG. 1, the network 118 of FIG. 1, and a plurality of monitored locations 102A through 102N of FIG. 1 (collectively referred to as the locations 102) are schematically illustrated. As shown in FIG. 5, the data center environment 124 hosts the surveillance service 128 and the transport services 126 (individually referred to as the transport services 126A through 126D). The surveillance service 128 includes a location data store 502, a sensor data store 504, an artificial intelligence (AI) service 508, an event listening service 510, and an identity provider 512. The monitoring center environment 120 includes computing devices 518A through 518M (collectively referred to as the computing devices 518) that host monitor interfaces 130A through 130M. Individual locations 102A through 102N include base stations (e.g., the base station 114 of FIG. 1, not shown) that host the surveillance clients 136A through 136N (collectively referred to as the surveillance clients 136) and image capture devices (e.g., the image capture device 110 of FIG. 1, not shown) that host the software camera agents 138A through 138N (collectively referred to as the camera agents 138).

As shown in FIG. 5, the transport services 126 are configured to process ingress messages 516B from the customer interface 132A, the surveillance clients 136, the camera agents 138, and/or the monitor interfaces 130. The transport services 126 are also configured to process egress messages 516A addressed to the customer interface 132A, the surveillance clients 136, the camera agents 138, and the monitor interfaces 130. The location data store 502 is configured to store, within a plurality of records, location data in association with identifiers of customers for whom the location is monitored. For example, the location data may be stored in a record with an identifier of a customer and/or an identifier of the location to associate the location data with the customer and the location. The sensor data store 504 is configured to store, within a plurality of records, sensor data (e.g., one or more frames of image data) separately from other location data but in association with identifiers of locations and timestamps at which the sensor data was acquired. In some examples, the sensor data store 504 is optional and may be use, for example, where the sensor data house therein has specialized storage or processing requirements.

Continuing with the example of FIG. 5, the AI service 508 is configured to process sensor data (e.g., images and/or sequences of images) to identify movement, human faces, and other features within the sensor data. The event listening service 510 is configured to scan location data transported via the ingress messages 516B for event data and, where event data is identified, execute one or more event handlers to process the event data. In some examples, the event handlers can include an event reporter that is configured to identify reportable events and to communicate messages specifying the reportable events to one or more recipient processes (e.g., a customer interface 132 and/or a monitor interface 130). In some examples, the event listening service 510 can interoperate with the AI service 508 to identify events from sensor data. The identity provider 512 is configured to receive, via the transport services 126, authentication requests from the surveillance clients 136 or the camera agents 138 that include security credentials. When the identity provider 512 can authenticate the security credentials in a request (e.g., via a validation function, cross-reference look-up, or some other authentication process), the identity provider 512 can communicate a security token in response to the request. A surveillance client 136 or a camera agent 138 can receive, store, and include the security token in subsequent ingress messages 516B, so that the transport service 126A is able to securely process (e.g., unpack/parse) the packages included in the ingress messages 516B to extract the location data prior to passing the location data to the surveillance service 128.

Continuing with the example of FIG. 5, the transport services 126 are configured to receive the ingress messages 516B, verify the authenticity of the messages 516B, parse the messages 516B, and extract the location data encoded therein prior to passing the location data to the surveillance service 128 for processing. This location data can include any of the location data described above with reference to FIG. 1. Individual transport services 126 may be configured to process ingress messages 516B generated by location-based monitoring equipment of a particular manufacturer and/or model. The surveillance clients 136 and the camera agents 138 are configured to generate and communicate, to the surveillance service 128 via the network 118, ingress messages 516B that include packages of location data based on sensor information received at the locations 102.

Continuing with the example of FIG. 5, the computing devices 518 are configured to host the monitor interfaces 130. In some examples, individual monitor interfaces 130A-130M are configured to render GUIs including one or more image frames and/or other sensor data. In certain examples, the customer device 122 is configured to host the customer interface 132. In some examples, customer interface 132 is configured to render GUIs including one or more image frames and/or other sensor data. Additional aspects of the monitor interfaces 130 and the customer interface 132 are described further below with reference to FIG. 6.

Turning now to FIG. 6, a monitoring process 600 is illustrated as a sequence diagram. The process 600 can be executed, in some examples, by a security system (e.g., the security system 100 of FIG. 1). More specifically, in some examples, at least a portion of the process 600 is executed by the location-based devices under the control of device control system (DCS) code (e.g., either the code 308 or 408) implemented by at least one processor (e.g., either of the processors 300 or 400 of FIGS. 3-4D). The DCS code can include, for example, a camera agent (e.g., the camera agent 138 of FIG. 1). At least a portion of the process 600 is executed by a base station (e.g., the base station 114 of FIG. 1) under control of a surveillance client (e.g., the surveillance client 136 of FIG. 1). At least a portion of the process 600 is executed by a monitoring center environment (e.g., the monitoring center environment 120 of FIG. 1) under control of a monitor interface (e.g., the monitor interface 130 of FIG. 1). At least a portion of the process 600 is executed by a data center environment (e.g., the data center environment 124 of FIG. 1) under control of a surveillance service (e.g., the surveillance service 128 of FIG. 1) or under control of transport services (e.g., the transport services 126 of FIG. 1). At least a portion of the process 600 is executed by a customer device (e.g., the customer device 122 of FIG. 1) under control of a customer interface (e.g., customer interface 132 of FIG. 1).

As shown in FIG. 6, the process 600 starts with the surveillance client 136 authenticating with an identity provider (e.g., the identity provider 512 of FIG. 5) by exchanging one or more authentication requests and responses 604 with the transport service 126. More specifically, in some examples, the surveillance client 136 communicates an authentication request to the transport service 126 via one or more API calls to the transport service 126. In these examples, the transport service 126 parses the authentication request to extract security credentials therefrom and passes the security credentials to the identity provider for authentication. In some examples, if the identity provider authenticates the security credentials, the identity provider generates a security token and transmits the security token to the transport service 126. The transport service 126, in turn, receives a security token and communicates the security token as a payload within an authentication response to the authentication request. In these examples, if the identity provider is unable to authenticate the security credentials, the transport service 126 generates an error code and communicates the error code as the payload within the authentication response to the authentication request. Upon receipt of the authentication response, the surveillance client 136 parses the authentication response to extract the payload. If the payload includes the error code, the surveillance client 136 can retry authentication and/or interoperate with a user interface of its host device (e.g., the user interface 212 of the base station 114 of FIG. 2) to render output indicating the authentication failure. If the payload includes the security token, the surveillance client 136 stores the security token for subsequent use in communication of location data via ingress messages. It should be noted that the security token can have a limited lifespan (e.g., 1 hour, 1 day, 1 week, 1 month, etc.) after which the surveillance client 136 may be required to reauthenticate with the transport services 126.

Continuing with the process 600, one or more DCSs 602 hosted by one or more location-based devices acquire (at operation 606) sensor data descriptive of a location (e.g., the location 102A of FIG. 1). The sensor data acquired can be any of a variety of types, as discussed above with reference to FIGS. 1-4D. In some examples, one or more of the DCSs 602 acquire sensor data continuously. In some examples, one or more of the DCSs 602 acquire sensor data in response to an event, such as expiration of a local timer (a push event) or receipt of an acquisition polling signal communicated by the surveillance client 136 (a poll event). In certain examples, one or more of the DCSs 602 stream sensor data to the surveillance client 136 with minimal processing beyond acquisition and digitization. In these examples, the sensor data may constitute a sequence of vectors with individual vector members including a sensor reading and a timestamp. Alternatively or additionally, in some examples, one or more of the DCSs 602 execute additional processing of sensor data, such as generation of one or more summaries of multiple sensor readings. Further still, in some examples, one or more of the DCSs 602 execute sophisticated processing of sensor data. For instance, if the security sensor includes an image capture device, the security sensor may execute image processing routines such as edge detection, motion detection, facial recognition, threat assessment, and reportable event generation.

Continuing with the process 600, the DCSs 602 communicate the sensor data 608 to the surveillance client 136. As with sensor data acquisition, the DCSs 602 can communicate the sensor data 608 continuously or in response to an event, such as a push event (originating with the DCSs 602) or a poll event (originating with the surveillance client 136).

Continuing with the process 600, the surveillance client 136 monitors 610 the location by processing the received sensor data 608. For instance, in some examples, the surveillance client 136 executes one or more image processing routines. These image processing routines may include any of the image processing routines described above with reference to the operation 606. By distributing at least some of the image processing routines between the DCSs 602 and surveillance clients 136, some examples decrease power consumed by battery-powered devices by off-loading processing to line-powered devices. Moreover, in some examples, the surveillance client 136 may execute an ensemble threat detection process that utilizes sensor data 608 from multiple, distinct DCSs 602 as input. For instance, in at least one example, the surveillance client 136 will attempt to corroborate an open state received from a contact sensor with motion and facial recognition processing of an image of a scene including a window to which the contact sensor is affixed. If two or more of the three processes indicate the presence of an intruder, the threat score is increased and or a break-in event is declared, locally recorded, and communicated. Other processing that the surveillance client 136 may execute includes outputting local alarms (e.g., in response to detection of particular events and/or satisfaction of other criteria) and detection of maintenance conditions for location-based devices, such as a need to change or recharge low batteries and/or replace/maintain the devices that host the DCSs 602. Any of the processes described above within the operation 610 may result in the creation of location data that specifies the results of the processes.

Continuing with the process 600, the surveillance client 136 communicates the location data 614 to the surveillance service 128 via one or more ingress messages 612 to the transport services 126. As with sensor data 608 communication, the surveillance client 136 can communicate the location data 614 continuously or in response to an event, such as a push event (originating with the surveillance client 136) or a poll event (originating with the surveillance service 128).

Continuing with the process 600, the surveillance service 128 processes 616 received location data. For instance, in some examples, the surveillance service 128 executes one or more routines described above with reference to the operations 606 and/or 610. Additionally or alternatively, in some examples, the surveillance service 128 calculates a threat score or further refines an existing threat score using historical information associated with the location identified in the location data and/or other locations geographically proximal to the location (e.g., within the same zone improvement plan (ZIP) code). For instance, in some examples, if multiple break-ins have been recorded for the location and/or other locations within the same ZIP code within a configurable time span including the current time, the surveillance service 128 may increase a threat score calculated by a DCS 602 and/or the surveillance client 136. In some examples, the surveillance service 128 determines, by applying a set of rules and criteria to the location data 614, whether the location data 614 includes any reportable events and, if so, communicates an event report 618A and/or 618B to the monitor interface 130 and/or the customer interface 132. A reportable event may be an event of a certain type (e.g., break-in) or an event of a certain type that satisfies additional criteria (e.g., movement within a particular zone combined with a threat score that exceeds a threshold value). The event reports 618A and/or 618B may have a priority based on the same criteria used to determine whether the event reported therein is reportable or may have a priority based on a different set of criteria or rules.

Continuing with the process 600, the monitor interface 130 interacts 620 with monitoring personnel through, for example, one or more GUIs. These GUIs may provide details and context regarding one or more events that warrant reporting to a user. In some examples, the monitor interface 130 is configured to interact with monitoring personnel to both receive input and render output regarding alarms or other events triggered at monitored locations, such as the location 102A. For instance, in some examples, the monitor interface 130 is configured to notify monitoring personnel of the occurrence of events at monitored locations, render audio-visual data and other sensor data collected by location-based devices at the monitored locations and stored in the data stores 502 and/or 504, and establish real time connections with location-based devices. Further, in some examples, the monitor interface 130 includes controls configured to receive input specifying actions taken by the monitoring personnel to address the events, such as interacting with actors including customers, customer contacts, dispatchers, and/or first responders called upon to investigate alarms. These actions can include, for example, taking or making calls from or to customers regarding an alarm or other event; verifying the authenticity of an alarm; making contact with individuals at a location reporting an alarm; calling an appropriate Public Service Answering Point (PSAP) to request dispatch of emergency responders, such as police, fire, or emergency medical services; updating status information regarding such dispatches; updating status information for an event; and canceling alarms and/or dispatched responders, to name a few actions. Some or all of these and other actions may be translated, by the monitor interface 130, into events that are communicated to the surveillance service 128 via a monitoring API, for example.

Continuing with the process 600, the customer interface 132 interacts 622 with at least one customer through, for example, one or more GUIs. These GUIs may provide details and context regarding one or more reportable events.

It should be noted that the processing of sensor data and/or location data, as described above with reference to the operations 606, 610, and 616, may be executed by processors disposed within various parts of the system 100. For instance, in some examples, the DCSs 602 execute minimal processing of the sensor data (e.g., acquisition and streaming only) and the remainder of the processing described above is executed by the surveillance client 136 and/or the surveillance service 128. This approach may be helpful to prolong battery runtime of location-based devices. In other examples, the DCSs 602 execute as much of the sensor data processing as possible, leaving the surveillance client 136 and the surveillance service 128 to execute only processes that require sensor data that spans location-based devices and/or locations. This approach may be helpful to increase scalability of the system 100 with regard to adding new locations.

As disclosed herein, the triggering and subsequent handling of events may involve actions taken by various system components and people interacting with such components (generally referred to herein as “actors”). Examples of such actors include the overall security system, location-based devices (e.g., cameras and other sensors) included in the security system, customers of the security system, contacts associated with the customers, monitoring personnel who keep watch over locations protected by the security system, dispatchers who interact with the monitoring personnel, and first responders who interact with the dispatchers and visit the locations, to name a few. These actors may work quasi-independently to handle events and, in doing so, may interact with various automation, such as mobile phone apps, text messaging, monitoring applications, computer-aided dispatch systems, and other automation.

Furthermore, there are numerous actions that can be taken by any of these actors. A few specific examples follow. At a monitored location, a sensor other than the sensor that triggered an event may be concurrently or subsequently triggered and therefore may supply additional information useful in resolving the event. For instance, a motion sensor may be triggered subsequent to a door sensor that triggered an alarm. A customer may arm or disarm their location-based devices. Monitoring personnel may initiate a call with a customer, a customer contact, or other individual. For example, monitoring personnel may initiate a live, interactive communication session with someone at the monitored location. Monitoring personnel may request dispatch of a first responder from a dispatcher. Monitoring personnel may cancel a requested dispatch via the dispatcher. A first responder may arrive at the monitored location. It can be useful for a user to have a concise and easy way to monitor or review actions that are happening, or have happened, at a monitored location.

Accordingly, examples disclosed herein provide a concise, accessible graphical interface by which a user can review handling of alarms and/or other events, including actions taken by monitoring personnel. As described above, in some examples, the GUI displays event cards that present a record of events at the monitored location 102A. In some examples, some or all events that happen at the monitored location 102A may cause the system to produce corresponding event cards, with each card presenting information about the corresponding event. As described further below, in some examples, the event cards show dynamic information about event handling by monitoring professionals based on what the monitoring professional sees in the live stream or recording from a particular image capture device 110. In this manner, the event cards may provide users with the most up to date information about what happened in the event, and keep a record in detail of the resolution of the event. In some instances, multiple events may occur close in time at the monitored location 102A. In such instances, the GUI can be configured to display a timeline that includes multiple event cards, with individual cards presenting the most up to date information for a corresponding event. In certain instances, multiple devices may be involved in a single event (e.g., multiple sensors may detect activity related to the same event). In such instances, the GUI can be configured to display a timeline that includes multiple event cards, with individual cards presenting the most up to date information for a corresponding event as detected by a corresponding device. Further, in some examples, the GUI can be configured to display a timeline that includes a chronological sequence of event cards relating to one or more events at the monitored location 102A. Examples are described further below.

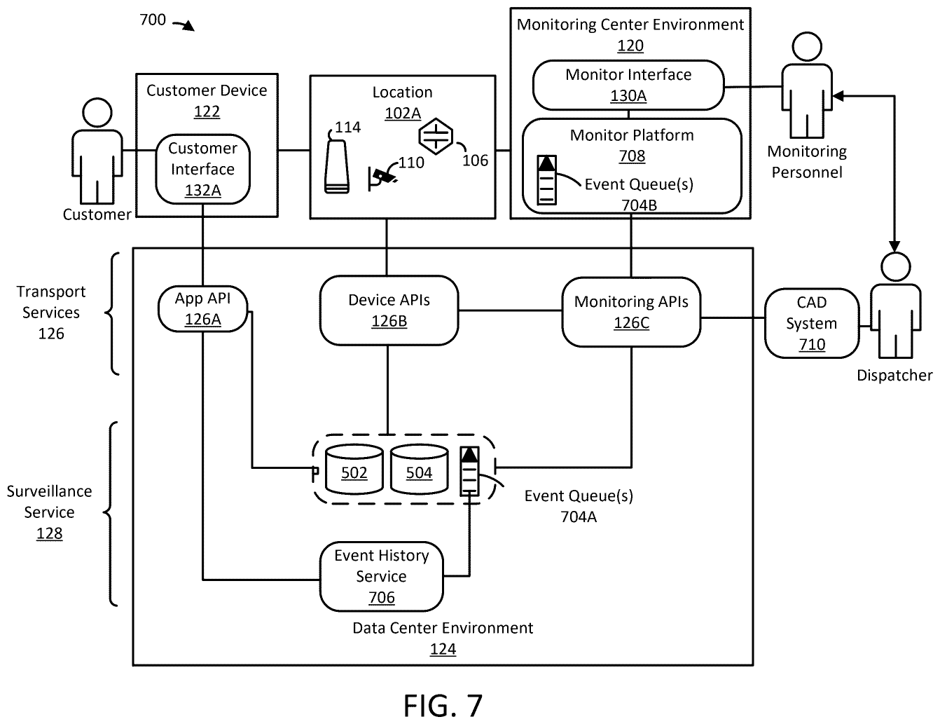

Turning now to FIG. 7, parts 700 of a system (e.g., the security system 100 of FIG. 1) that are configured to implement a GUI with a timeline (e.g., an event timeline), and/or configured to display event cards, are schematically illustrated. These parts include the data center environment 124 of FIG. 1, the monitoring center environment 120 of FIG. 1, one of the customer devices 122 of FIG. 1, and a monitored location 102A of FIG. 1. As shown in FIG. 7, the data center environment 124 hosts portions of the surveillance service 128 including the location data store 502 of FIG. 5, the sensor data store 504 of FIG. 5, one or more event queues 704A, and an event history service 706. The data center environment 124 further hosts portions of the transport services 126 including an app API 126A, one or more device APIs 126B, and one or more monitoring APIs 126C. The monitoring center environment 120 includes at least one computing device that hosts a monitor interface 130A and, in this example, at least one computing device that hosts a monitor platform 708. The monitor platform 708 includes one or more event queues 704B. The data center environment 124 optionally includes one or more other queues (e.g., message queues) to persist event data, for example. The processes 126A, 126B, 126C, and 706 may interoperate with the message queues to manage flow of event data. The location 102A includes a base station 114, an image capture device 110, and a sensor 106. The base station 114 may host a surveillance client (e.g., the surveillance client 136 of FIG. 1; not shown in FIG. 7). The image capture device 110 may host a software camera agent (e.g., the camera agent 138 of FIG. 1; not shown in FIG. 7). The sensor 106 may host a DCS (e.g., as described above with reference to FIG. 4A; not shown in FIG. 7). As will be apparent in view of this disclosure, the location-based devices 114, 110, and 106 are illustrated by way of example only and the location 102A may omit any of these devices or include other devices. Similarly, examples illustrated by FIG. 7 are not limited to a single customer device 122, location 102A, or monitoring center environment 120. In general, the monitor platform 708 may be collocated with the monitoring center (as illustrated in FIG.

7), collocated with the rest of the surveillance service (as part of data center environment 124), or independently hosted. It should be noted that the parts of 700 of the system illustrated in FIG. 7 may interoperate with one another via one or more messages (e.g., inter-process communications generated by API calls and response or the like).

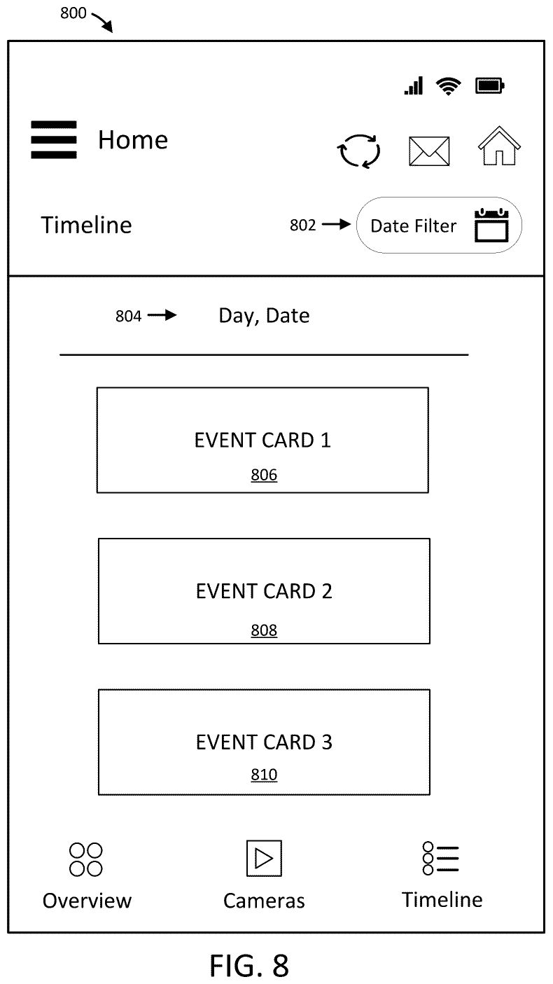

As shown in FIG. 7, the customer interface 132A comprises an application (“app”) that is hosted by the customer device 122. In some examples, the customer interface 132A is configured to interact with a customer to both receive input and render output regarding aspects of the system accessible to the customer. For instance, in certain examples, the customer interface 132A is configured to control its host to render a GUI with controls configured to display a chronology of actions (e.g., an event timeline) taken by the various actors involved in handling an event or collection of events. As described further herein, the timeline of events can include information about individual events, as well as information about collections of events. In some instances, an individual event or a collection of events may trigger an alarm, in which case the timeline can include information about the event(s) that triggered the alarm, event(s) that occurred subsequent to the triggering of the alarm, and a current status of the alarm. In some examples, the timeline can include event cards that initially reflect a trigger of an event (e.g., motion) and that are updated to reflect the current status of the event (event handling and/or disposition). In certain examples, additional controls configured to enable a customer or user to take actions related to an event, such as accessing video recordings related to the event (e.g., as may be stored in the location data store 502 and/or the sensor data store 504), requesting help regarding the event, and, in the case of an alarm, canceling the alarm, both with regard to location-based devices and remote monitoring personnel, may be provided. FIG. 8 illustrates an example of a screen 800 of a GUI with dynamic event cards that a device hosting the customer interface 132A can render in some examples.

Continuing with the example of FIG. 7, the location-based devices 114, 110, and 106 are configured to detect events (e.g., reportable events) that occur at the location 102A and communicate messages regarding the events and other information (e.g., location data) to the surveillance service 128 via the device APIs 126B. This other information can include, for example, audio-visual sensor data acquired by the image capture device 110 and arm/disarm events processed by the location-based devices. These messages communicated by the location based devices 114, 110, and 106 may include, for example, event data.

In some examples, the monitor interface 130A comprises a browser-based application and/or portal hosted by computing devices within the monitoring center environment 120 and served by the monitor platform 708. For example, in one implementation the monitor interface 130A comprises a combination of an application provided by the monitoring agency provider that interacts with the monitor platform 708, and a browser-based extension for video verification that interacts with the data center environment 124 via the monitoring APIs 126C. The monitor interface 130A is configured to interact with monitoring personnel to both receive input and render output regarding certain events, including alarms, triggered at monitored locations, such as the location 102A. For instance, in some examples, the monitor interface 130A is configured to notify monitoring personnel of the occurrence of events at monitored locations, render audio-visual data and other sensor data collected by location-based devices at the monitored locations and stored in the data stores 502 and/or 504, and establish connections (e.g., real time connections) with location-based devices. Further, in some examples, the monitor interface 130A includes controls configured to receive input specifying actions taken by the monitoring personnel to address the events and/or alarms, such as interacting with actors including customers, customer contacts, dispatchers, and/or first responders called upon to investigate the events or alarms. These actions can include, for example, taking or making calls from or to customers regarding an event and/or alarm; verifying the authenticity of an alarm; making contact with individuals at a location reporting an event and/or alarm; calling an appropriate Public Safety Answering Point (PSAP) to request dispatch of emergency responders, such as police, fire, or emergency medical services; updating status information regarding such dispatches; updating status information for events and/or alarms; and canceling alarms and/or dispatched responders, to name a few actions. Some or all of these and other actions are handled by the monitor platform 708, which may then translate them into events that are communicated to the surveillance service 128 via the monitoring APIs 126C.

Continuing with the example of FIG. 7, the monitor platform 708 is configured to interoperate with a plurality of monitor interfaces, including the monitor interface 130A. In some examples where the monitor interface 130A is a browser-based application, the monitor platform 708 serves the monitor interface 130A to a browser executing on a computing device accessible by monitoring personnel. Alternatively or additionally, in certain examples, the monitor platform 708 operates as a service to a specialized, native version of the monitor interface 130A executing on the computing device accessible by monitoring personnel. Regardless of its particular method of implementation, the monitor platform 708 exchanges messages with the monitor interface 130A to drive workflows conducted by monitoring personnel (e.g., reviewing events occurring at monitored locations, contacting monitoring agency customers, contacting dispatchers, following up on events, canceling false alarms, closing out fully addressed events and/or alarms, etc.). In some examples, the monitor platform 708 includes the event queue 704B that stores data representative of events currently being handled by monitoring personnel. In these examples, the event queue 704B may identify individual events and may prioritize the events for urgency in handling, relative to one another.

Continuing with examples illustrated by FIG. 7, the monitor platform 708 may be configured to receive event data from the data center environment 124 (e.g., from the event queues 704A via the monitoring APIs 126C) and to store the event data in the event queue 704B. In these examples, the monitor platform 708 is further configured to receive one or more messages from the monitor interface 130A specifying handling operations originated by a monitoring professional. These handling operations may include, for example, selection (via interaction between the monitoring professional and the monitor interface 130A) of the event data for handling by the monitoring professional, designation that event handling is in process, and/or designation of a resolution of the event. In response to reception of a handling operation selecting the event data for handling, the monitor platform 708 can link (e.g., record an association between) the selected event data and the monitor interface 130A utilized by the monitoring professional. The monitor platform 708 may be further configured to notify the monitor interface 130A associated with the monitoring professional of subsequently enqueued event data regarding the event until event disposition.

As shown in FIG. 7, the monitor platform 708 is further configured to interoperate with the monitoring APIs 126C. For instance, in some examples, the monitor platform 708 is configured to exchange ingress and egress messages with the monitoring APIs 126C that generate events (e.g., reportable events). These events may result, for example, from actions taken by monitoring personnel as part of the workflows they perform. These events may include, for instance, initiation or escalation of an alarm initiated by monitoring personnel or a location-based device. The messages exchanged between the monitor platform 708 and the monitoring APIs 126C may further specify updates to event data resulting from handling operations. In some examples, the monitoring API 126C is configured to store update messages regarding the events in the event queue 704A for subsequent processing by the event history service 706.

Continuing with the example of FIG. 7, the app API 126A is configured to interoperate with the customer interface 132A to exchange ingress messages (e.g., the ingress messages 516B of FIG. 5) and egress messages (e.g., the egress messages 516A of FIG. 5) with the customer interface 132A. For instance, in some examples, the app API 126A establishes a connection (e.g., WebSocket or Socketlink connection) with the customer interface 132A, and the two processes communicate the ingress and egress messages therein. Alternatively or additionally, at least some of the ingress and egress messages are communicated via API (e.g., REST API) calls. The ingress and egress messages may include data (e.g., location data) specifying events and/or alarms, as described herein, as well as requests to cancel an alarm or send help to a location. The customer interface 132A can store event data generated by the customer interface 132A (e.g., a request to cancel an alarm) in the event queues 704A for subsequent processing. In some examples, the app API 126A interoperates with both the customer interface 132A and the event history service 706 to supply a sequence of events ordered by timestamp that can be used to produce an event timeline. In these examples, the event history service 706 may be further configured to communicate (e.g., push via the WebSocket or Socketlink connection) event data to the customer interface 132A (e.g., via the app API 126A). In certain examples, the app API 126A may be further configured to receive updated event data from the event history service 706 and supply the updated event data to the customer interface 132A which may, in turn, initiate one or more updates to one or more dynamic event cards in response thereto.

In some examples, the device APIs 126B are configured to interoperate with the location-based devices 114, 110, and 106 at the location 102A to exchange ingress messages (e.g., the ingress messages 516B of FIG. 5) and egress messages (e.g., the egress messages 516A of FIG. 5) with the location-based devices 114, 110, and 106. For instance, in some examples, the device APIs 126B establish WebSocket (or Socketlink) connections with DCS processes hosted by the location-based devices 114, 110, and/or 106, and the connected DCS processes communicate the ingress and egress messages via the WebSocket connections. The ingress and egress messages may include data specifying events (e.g. event data), as described herein. In some examples, the device APIs 126B are further configured to interoperate with the data stores 502 and/or 504 to store event and/or sensor data received from the location 102A. In these examples, the device APIs 126B are also configured to interoperate with the event queues 704A to place (e.g., enqueue) certain event data (e.g., reportable events) thereon for processing by the event history service 706. These events can be utilized by the event history service 706 to build event timelines related to particular incidents (e.g., collections of events, such as, but not limited to, alarms) and/or particular devices. The events placed on the event queues 704A may also be used by the event history service to generate messages specifying updates to event cards.

Continuing with the example of FIG. 7, the monitoring APIs 126C are configured to interoperate with a computer-aided dispatch (CAD) system 710 and/or the monitor platform 708 at the monitoring center environment 120 to exchange ingress messages (e.g., the ingress messages 516B of FIG. 5) and egress messages (e.g., the egress messages 516A of FIG. 5) with the monitor platform 708. For instance, in some examples, the monitoring APIs 126C establish WebSocket connections with the monitor platform 708, and the connected processes communicate the ingress and egress messages via the WebSocket connection. The ingress and egress messages may include data specifying events (e.g., event data). In some examples, the monitoring APIs 126C are further configured to interoperate with the data stores 502 and/or 504 to manipulate event and sensor data received from the location 102A. In these examples, the monitoring APIs 126C may be also configured to interoperate with the event queues 704A to place certain event data thereon for processing by the event history service 706. This event data can be utilized by the event history service 706 to build timelines of events and/or generate messages specifying updates to event cards, for example. In some examples, the monitoring APIs 126C support the Automated Secure Alarm Protocol and are configured to communicate messages specifying events with the CAD system 710 operated by dispatchers at PSAPs and to add to or modify the events stored in the event queues 704A and/or 704B. One example of a commercially available CAD system that may be used to implement the CAD system 710 is the PREMIERONE dispatch software commercially available from Motorola Solutions, Inc. of Chicago, Illinois, USA.

According to certain examples, the event queues 704A and 704B include one or more data structures and, in certain examples, surrounding services that support enqueuing and dequeuing of member data structures that house events (e.g., reportable events). The queues may be implemented using any of a variety of queuing technologies, such as KAFKA, IBM MQ, and AMAZON MQ to name a few. In some examples, the event queues 704A include a first queue for events inbound from the device APIs 126B, a second queue for events inbound from the monitoring APIs 126C, and a third queue for events inbound from the app API 126A.

In some examples, the event history service 706 can be configured to retrieve (e.g., dequeue) event data from the event queues 704A, optionally organize the event data into lists, and publish the organized lists to the app API 126A for delivery to the customer interface 132A. In certain examples, the event history service 706 maintains and refers to a filter that prevents and/or allows enumerated types of event data to be passed to the app API 126A. These types of event data may include, for example, initial event data and/or updated event data. For instance, in some examples, the event history service 706 is configured to process the retrieved event data, assign event identifiers to the event data, and publish the processed event data to the app API 126A. This processed event data may include an event identifier, initial event data that specifies, for example, one or more triggers (e.g., motion detection) and/or updated event data that specifies, for example, event handling information (e.g., monitoring personnel is reviewing sensor data) and/or event disposition information (e.g., event closed as being common, first responder dispatched to scene, etc.). In some examples, the event history service 706 is configured to assign a new event identifier when a device communicates a message including certain types event data (e.g., data indicative of a motion event, glass break event, contact sensor opening, etc.) and to assign the event identifier to subsequent update messages from the device until disposition of the event. Upon receipt of published event data, the customer interface 132A may dynamically update event cards as described further below.

According to certain examples, signals generated by system components can be routed to monitoring center environment 120 using, for example, monitoring APIs 126C. In these examples, the monitoring APIs 126C may be configured to receive event data (e.g., initial or updated event data) from the monitor platform 708 and/or the CAD system 710 and supply the event data to the event queues 704A. Monitoring and other event handling activities, such as dispatch of emergency services, can be handled by monitoring personnel associated with the monitoring center environment and/or other personnel downstream of the monitoring center environment (for example, dispatchers at a dispatch center). In certain implementations, actions taken by monitoring personnel and/or other downstream personnel can be reported back to data center environment 124. This provides transparency to the surveillance service 128, and in turn to customers, with respect to the handling of event.

As described above, in some examples, the customer interface 132A is configured to provide a GUI. FIG. 8 illustrates an example of a GUI screen 800 that includes a timeline of events. As shown in FIG. 8, the screen 800 includes a date filter control 802, a day control 804, and event cards 806-810. As shown in FIG. 8, the customer interface 132A is configured to respond to selection of the control 802 by prompting the user to select one or more dates and, in response to receiving a selection of dates, filter the cards 806-810 to those representing an event that occurred within the dates. The customer interface 132A may be further configured to display the day of week and date applicable to the cards 806-810 via the day control 804.

In some examples, the event cards 806-810 can include various information that may depend on the type of event described by a particular event card. For example, any one of the event cards 806-810 can identify what happened to trigger an event (e.g., a camera generated a motion event), which location-based sensor captured the event (e.g., the image capture device 110a), and for events involving monitoring agency personnel, what action was taken by the monitoring professional (e.g., monitoring professional viewed camera live, or monitoring professional started two-way audio). For events generated by an image capture device 110, for example, the event cards 806-810 can include further information regarding video imagery captured by the image capture device 110. For example, an event card may indicate whether a human (e.g., not necessarily a particulate individual) was detected, or how many (if any) faces were identified (e.g., uniquely or generally) in the video imagery via facial recognition, for example. The event card may further indicate how many images were captured and/or whether a video stream is available for the event, for example.

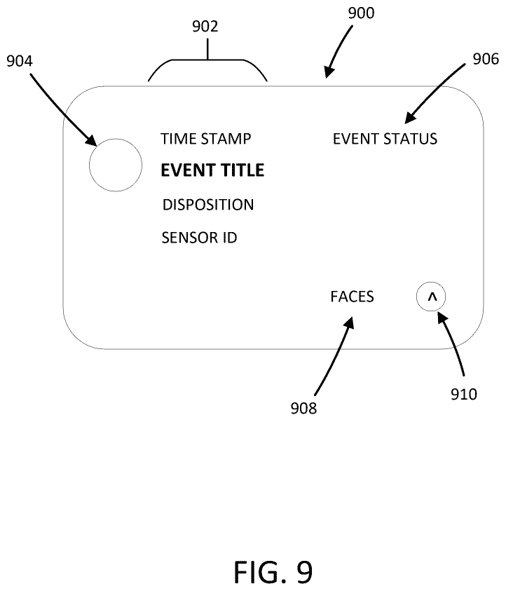

FIG. 9 illustrates an example of an event card 900 that may be presented to a user via a GUI screen, such as the screen 800 of FIG. 8, for example. As shown in FIG. 9, the card 900 includes a text control group 902, an icon 904, a status control 906, a face clip control 908, and a video access control 910.

In some examples, the customer interface 132A is configured to render, via the control group 902, textual information from event data linked or otherwise associated with the card 900. This textual information may include various items, for example, a time stamp, an event title, a disposition, and a sensor identification (ID). The time stamp may indicate the time of an event (e.g., 8:55 pm). The event title may identify or otherwise describe the event. For example, for a motion event detected by the image capture device 110, an event title of “person on property” may indicate that the event was a person being detected by the identified image capture device. The disposition may indicate an action taken by the system and/or user (e.g., a customer, a monitoring professional etc.). For example, as a monitoring professional is reviewing footage in a “person on property” event, the disposition may state “Agent handling.” If the monitoring professional then determines that the event is not an emergency (but still confirmed a person was on the property) the disposition may be updated to state “Agent handled event,” for example. According to certain examples, the disposition is updated dynamically as the monitoring professional handles the event. The sensor ID may identify the sensor that captured the event, optionally by a name or other label given to the particular sensor by the user. For example, the sensor ID may be “backyard camera” or “doorbell camera,” etc.

In some examples, the customer interface 132A is configured to visually differentiate between different types of events (and more specifically, for different types of events flagged for handling by a monitoring professional) via the icon 904. For example, the icon 904 may include one icon for (e.g., representative of) a motion detection event and a different icon for (e.g., representative of) a person detection event. The customer interface 132A may be further configured to visually indicate a status of the event corresponding to the card 900 via the control 906. For instance, the control 906 may include text, such as “monitored,” “not monitored,” “cleared,” or the like that indicates the status of the event. In certain examples (e.g., for event cards corresponding to events generated by the image capture device 110), the customer interface 132A is configured to indicate, via the control 908, a number of faces that have been identified in one or more images recorded during the event. In such examples, the customer interface 132A is configured to respond to selection of the control 910, which may be a button or menu option, by rendering the one or more images and/or one or more videos including the one or more images. In some examples, the controls 908 and 910 may be combined into a single control that indicates a number of faces that have been identified and that is selectable to access content depicting the faces (e.g., one or more images and/or one or more videos, per above).

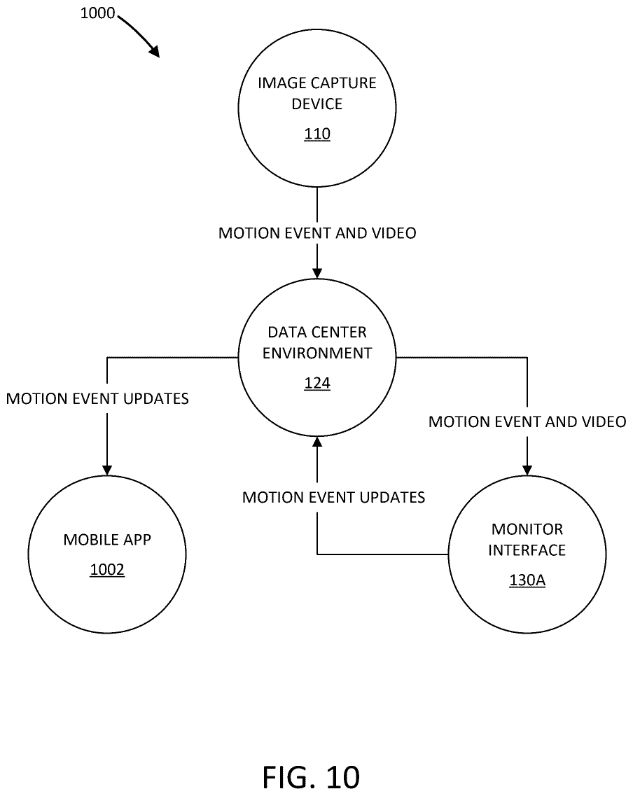

As described above, in some examples, the customer interface 132A is configured to show dynamic information about events via event cards such as the card 900. This dynamic information may specify monitoring professional handling activities, and in some examples can be updated while an event is ongoing (e.g., prior to and during disposition of the event) and as conditions of the event change. Further, multiple event cards from different events and/or different devices involved in the same event, can be displayed in an event timeline, as shown in FIG. 8, for example. Individual event cards can be updated in real time as the event unfolds, thereby providing the user with current information about the status of any event. Thus, a timeline including dynamic event cards can provide a user with concise, easy-to-understand, and current information about events at their monitored location, including transparency into monitoring professional handling of events in real time as well as a detailed record of the event and its resolution. An example of the generation and presentation of event cards for a sequence of motion events, as may be detected by the image capture device 110, for example, is described below with reference to FIGS. 10-13.

Referring to FIG. 10, there is illustrated a block diagram 1000 of parts of a system (e.g., the security system 100 of FIG. 1) that are involved in generating an event timeline including one or more event cards. These parts include the image capture device 110 of FIGS. 1 and 4A-D, the data center environment 124 of FIG. 1, the monitoring interface 130A of FIG. 7, and a mobile app 1002, which may be an example of one of the customer interfaces 132 of FIG. 1, (e.g., customer interface 132A of FIG. 7) and is hosted by a customer device 122.

In some examples, the image capture device 110 is the location-based device that generates a motion event upon detection of motion in front of the camera. As shown in FIG. 10, the image capture device 110 may detect motion (e.g., of a person or other object of interest within its field of view), as described above, and produce a signal indicating a motion event, along with video imagery (e.g., one or more still images and/or a video recording). The image capture device 110 sends the motion event signal and video imagery to the data center environment 124, optionally via the base station 114, as described above. For example, the image capture device 110 can communicate one or more messages regarding the motion event (including the video data) to the surveillance service 128 via the device APIs 126B, as described above with reference to FIG. 7.

Continuing with the example of FIG. 10, the data center environment 124 may include a set of cloud services to manage data communication and storage, as described above. For example, the data center environment 124 processes the incoming messages from the image capture device 110 and transmits messages regarding the motion event (including some or all of the video data) to the monitor interface 130A for viewing by monitoring personnel (e.g., a monitoring professional), as described above with reference to FIG. 7. Through the monitor interface 130A, the monitoring professional may review the video data and/or other information (including updates) relating to the motion event and trigger updates to the status of the event. For example, as the monitoring professional handles the event, updates from the monitoring professional about the event are transmitted (e.g., as one or more messages from the monitor interface 130A, as described above with reference to FIG. 7) to the data center environment 124. The data center environment 124 may communicate (e.g., push) information about the event to the mobile app 1002 (e.g., via the app API 126A as described above with reference to FIG. 7). The mobile app 1002 presents the information and updates about events (e.g., a motion event) to the user via a GUI. For example, the mobile app 1002 may display the information and updates in the form of one or more event cards 900, as described above with reference to FIG. 9.

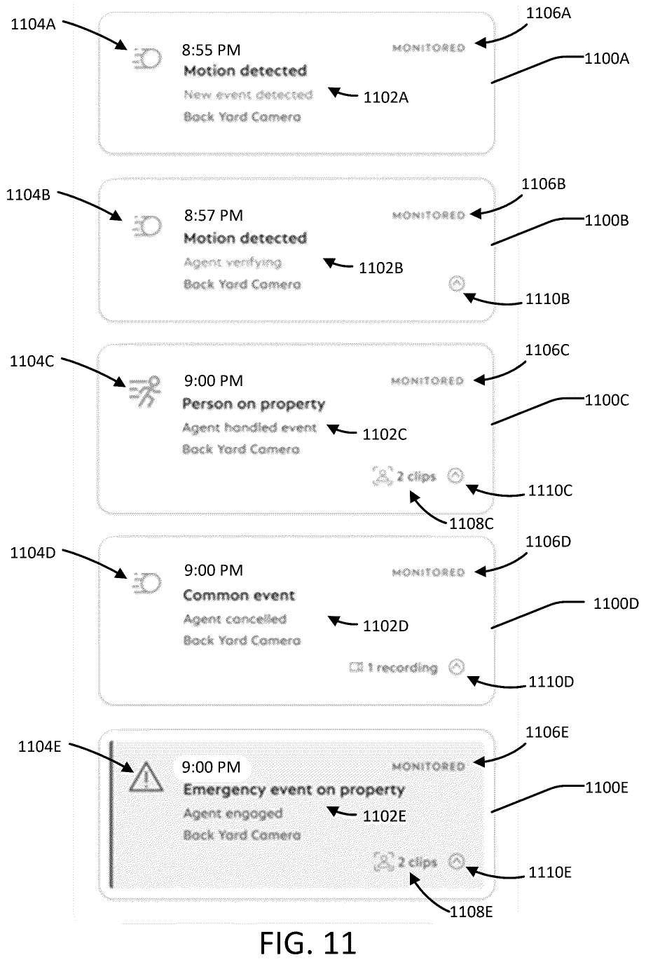

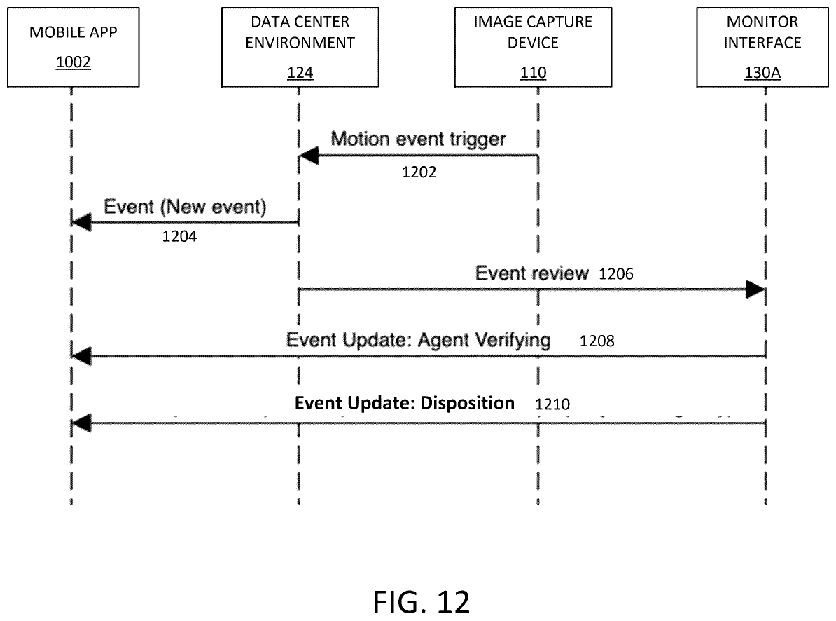

FIG. 11 illustrates an example of visual states 1100A-E of a dynamic event card, as may be displayed via the mobile app 1002 of FIG. 10 as an event unfolds. FIG. 12 illustrates an example of a sequence flow among the parts of FIG. 10 that may produce the states 1100A-E illustrated in FIG. 11.

Referring to FIGS. 11 and 12, in this example, the image capture device 110 detects motion in its field of view and generates a motion event at 1202. The motion event reaches the data center environment 124, along with video imagery, as described above. For example, information from the image capture device 110 can be populated into a queue (e.g., the event queue 704A) as described above. At the data center environment 124, the event history service 706 generates a new event message at 1204 that is communicated to, or otherwise obtained by, the mobile app 1002, as described above and further below. In some examples, in response to receiving the new event message, the mobile app 1002 generates a new event card (e.g., the event card 900 of FIG. 9) for the new event, identifies (e.g., based on event data specified within the obtained message) an action taken to handle the event, and renders the event card in a state indicative of the action taken (e.g., the state 1100A). In some examples, if the mobile app 1002 is not open when the new event message is received, the mobile app 1002 may prompt the user to open the GUI of the mobile app 1002. As shown in FIG. 11, in the state 1100A, the event card includes a text control group 1102A, an icon 1104A, and a status control 1106A. The control group 1102A indicates that a new motion event was detected by a back yard camera at 8:55 p.m. Likewise, the icon 1104A graphically indicates that a new motion event was detected. The control 1106A indicates that the back yard camera is subject to monitoring by a monitoring service.

Returning to FIG. 12, as described above, the data center environment 124 forwards information about the motion event to the monitoring center environment 120, e.g., via the monitoring APIs 126C. A monitoring professional may pick up the event from a queue, as described above, and review the information, at 1206, via the monitor interface 130A. As shown in FIG. 12, as the monitoring professional reviews, an update message is provided to the mobile app 1002 at 1208. Accordingly, the mobile app 1002 updates (e.g., changes) the event card to the state 1100B, which indicates that the status of the motion event has changed from “new event detected” (as shown in the event card state 1100A) to “agent verifying” (as shown in the event card 1100B). More specifically, in the state 1100B, the event card includes a text control group 1102B, an icon 1104B, a status control 1106B, and a video access control 1110B. The control group 1102B indicates that review by a monitoring professional (“agent”) is underway (e.g., the monitoring professional has begun investigating (“verifying”) the motion event at 8:57 p.m.). The icon 1104B and the control 1106B remain unchanged from their predecessors 1104A and 1106A. However, the control 1110B indicates that video content is available for review via its selection.

Returning to FIG. 12, based on review of the event information and video imagery (e.g., a video recording or still image from the image capture device and/or a live video stream from the image capture device), the monitoring professional determines the disposition of the event. The monitoring professional may then update the disposition of the event, and that update can be communicated via a message from the monitor interface 130A to the mobile app 1002 at 1210. In some examples, the disposition can include any one of various status identifiers, such as “Common event” (e.g., the motion event was caused by a pet, tree branch, passing car, or some other common occurrence/common activity at the monitored location 102A), “Person on property” (e.g., a person was detected, either through the monitoring professional's review of the video imagery or via object detection processes operated by the image capture device 110 or data center environment 124, as described above), or “Emergency event on property” (e.g., the monitoring professional determines that a detected person appears to be an intruder). The disposition update at 1210 can be propagated in real time to the mobile app 1002, for example, over a Socketlink, a direct connection between the data center environment 124 and the mobile app 1002, or via another communication link.

FIG. 11 illustrates examples of event cards states 1100C-E that may be generated in response to the three different disposition examples described above. For example, state 1100C illustrates an example of an updated event card for a “Person on property” disposition. In this example, the disposition indicates that the monitoring professional handled the event, and the title of the state 1100C is updated to “Person on property.” In addition, the iconography is altered as described above. For example, the states 1100A and 1100B illustrate “motion detected” icons 1104A and 1104B, wherein in the state 1100C, a “person detected” icon 1104C is illustrated. More particularly, in the state 1100C, the event card includes a text control group 1102C, an icon 1104C, a status control 1106C, a face clip control 1108C, and a video access control 1110C. The control group 1102C indicates that a monitoring professional (“agent”) has resolved (“handled”) the motion event at 9:00 p.m. The control group 1102C further indicates that the monitoring professional identified the source of the motion event as being a person who is authorized to be at the location. The icon 1104C graphically indicates that a person who is authorized to be at the location was identified as being the source of the motion event. The controls 1106C and 1110C remain unchanged from their predecessors 1106B and 1110B. However, the control 1108C indicates that the video content available for review includes 2 images of one or more humans captured by the back yard camera.

Event card state 1100D illustrates an example of an updated event card for a “Common event” disposition. In this example, the disposition indicates that the monitoring professional cancelled the event, since it was determined that no threat was present. More specifically, in the state 1100D, the event card includes a text control group 1102D, an icon 1104D, a status control 1106D, and a video access control 1110D. The control group 1102D indicates that a monitoring professional (“agent”) has resolved (“cancelled”) the motion event at 9:00 p.m. The control group 1102D further indicates that the monitoring professional identified the source of the motion event as being a common event (e.g., motion involving an object other than a human) at the location. The icon 1104D and controls 1106D and 1110D remain unchanged from their predecessors 1104B, 1106B, and 1110B. However, the control 1108D indicates that the video content available for review includes 1 recording captured by the back yard camera. In some examples, the “Common event” disposition may be referred to, and identified as, a “Common activity” disposition within the event care data 1100D.

Event card state 1100E illustrates an example of an updated event card for an “Emergency event on property” disposition. In this example, the disposition indicates that the monitoring professional is engaged, handling the event (e.g., contacting user contacts, emergency dispatches, etc.) and the iconography is updated to display an emergency icon 1104E. In addition, in some examples, in the state 1100E, a background color of the event card can be altered relative to other event cards, so as to visually highlight the emergency to the user. More particularly, in the state 1100E, the event card includes a text control group 1102E, an icon 1104E, a status control 1106E, a face clip control 1108E, and a video access control 1110E. The control group 1102E indicates that a monitoring professional (“agent”) interacted with (“engaged”) the source of the motion event and/or requested (“engaged”) dispatch of a first responder to the location. The control group 1102E further indicates that the monitoring professional identified (at 9:00 p.m.) the source of the motion event as being an emergency event (e.g., an intruder, fire, of some other urgent situation) at the location. The icon 1104E graphically indicates an emergency event at the location was identified as being the source of the motion event. The controls 1106E and 1110E remain unchanged from their predecessors 1106B and 1110B. However, the control 1108E indicates that the video content available for review includes 2 images of one or more humans captured by the back yard camera.

According to certain examples, motion events generated by the image capture device 110 (or other events triggered by other sensors) contain metadata that can be used to generate and update event cards to states 1100A-E. For example, the metadata can include attributes such as event status and/or action descriptions that can be processed by the event history service 706 and/or the mobile app 1002 to generate and update event cards to states 1100A-E. The event status metadata can include information that identifies the status of an event, such as whether the event is monitored, cancelled, being handled, etc. The action description metadata can include information about actions taken by one or more actors (e.g., customers, monitoring personnel, etc.), such as whether a disarm was requested, whether emergency services were dispatched, whether an alarm was cancelled, etc. According to certain examples, the mobile app 1002 reads values of these (and/or other) attributes in the metadata to determine the state of the corresponding event card for a monitored camera motion (or other) event. According to certain examples, disposition actions can be mapped by the mobile app 1002 to updates that are presented in the event card states 1100A-E based at least in part on the metadata.

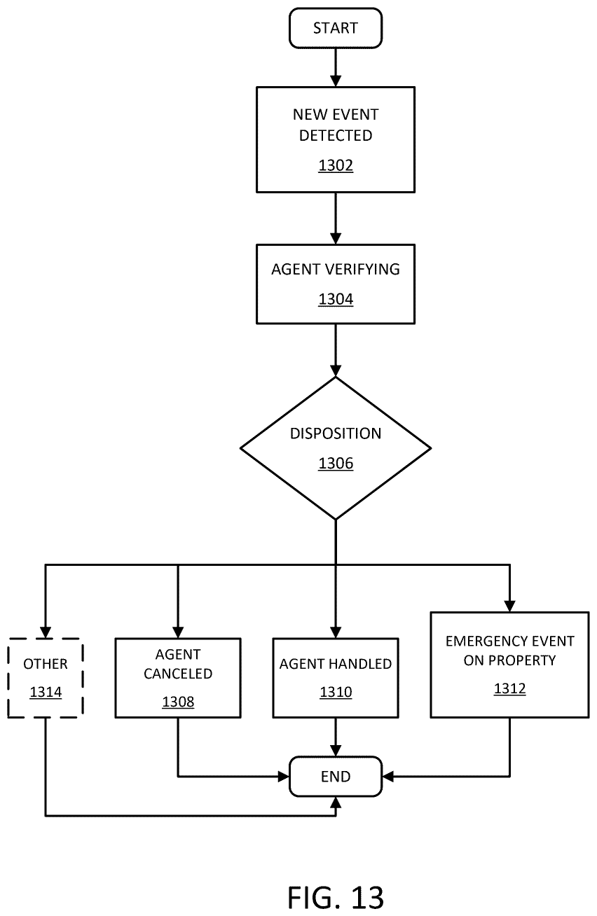

FIG. 13 illustrates a flow diagram of an example motion event lifecycle corresponding to the example of FIGS. 11 and 12.

At operation 1302, motion is detected by the image capture device 110, generating a new motion event. According to certain examples, if the user is actively looking at the screen 800 of FIG. 8 for the monitored location 102A while the image capture device 110 detects motion and generates an event, then the user will see a new event card appear. The new event card may be in a visual state (e.g., the event card state 1100A) tailored to the event for a “Motion detected” event. As illustrated in FIG. 11, in some examples, the status/disposition for the event at this stage indicates “New event detected.”

At operation 1304, when a monitoring professional picks up the event to review the video stream and/or other content, a new event may be sent to the mobile app 1002 with the same event identification as the original motion triggered event, but with updated data. The mobile app 1002 may then update the event card to the state 1100B, for example, indicating that the status is “Agent Verifying”.

At operation 1306, once the monitoring professional has determined the outcome of the event, they will set a disposition on the event. The disposition at operation 1306 in turn triggers additional event data to be sent to the mobile app 1002. The mobile app 1002 receives this event data and updates the state of the event card to the most accurate disposition based on what the monitoring professional indicated via the monitor interface 130A. For example, if the disposition is “agent cancelled” at operation 1308, the event card state 1100D may be presented. Alternatively, if the disposition is “agent handled” at operation 1310, for example, the state 1100C may be presented. In another example, if the disposition is “emergency event on property” at operation 1312, the event card state 1100E may be presented. In certain examples, one or more other event card states may be triggered at operation 1314. Numerous variations and other examples are envisioned and are intended to be part of this disclosure.

It should be noted that event lifecycles, as described herein, are not limited to the lifecycle illustrated in FIG. 13. For instance, in some examples, new events may be updated any number of times between initialization and disposition. Moreover, in at least some examples, events may be linked with a particular device, which may continue to generate updated event data until disposition occurs. In these examples, new events are device-specific, as such a single intruder may trigger multiple new events and new event cards that may be individually updated until each new event is resolved.

Thus, aspects and examples provide techniques by which real time updates of the status of an event can be communicated using event card visual states. Updates to visual states may be based on an identification of an action taken by a monitoring professional through analysis of information pertaining to that event. It will be appreciated that the monitoring professional may be a person, an artificial intelligence process (e.g., one or more computer-implemented motion detection and/or object detection processes), or a combination of both. The mobile app 1002 may “listen” to event updates on a socket connection to the data center environment 124, as described above. As the monitoring professional starts to review an event, a message to that effect can be forwarded to the mobile app 1002 to allow the mobile app to update the states of an event card accordingly, as described above (e.g., to monitoring professional reviewing status). Further, as a monitoring professional updates the event disposition, another message can be sent to the mobile app 1002 while open on the user device 122 (e.g., the user's phone or other computing device), and the mobile app 1002 can dynamically update the state of the event card to reflect the most up-to-date disposition of the event.

Examples described herein provide techniques by which more detailed information can be added to all types of event cards, not limited to the motion event examples described above. By updating monitoring professional action and disposition information in the event cards, users may be provided with greater transparency as to what actions are being taken by the monitoring professional as the monitoring professional handles a given event. For example, in the case of an intrusion event, the event card can take on a visual state that indicates whether the monitoring professional engaged with the intruder and in what way.

Turning now to FIG. 14, a computing device 1400 is illustrated schematically. As shown in FIG. 14, the computing device includes at least one processor 1402, volatile memory 1404, one or more interfaces 1406, non-volatile memory 1408, and an interconnection mechanism 1414. The non-volatile memory 1408 includes code 1410 and at least one data store 1412.

In some examples, the non-volatile (non-transitory) memory 1408 includes one or more read-only memory (ROM) chips; one or more hard disk drives or other magnetic or optical storage media; one or more solid state drives (SSDs), such as a flash drive or other solid-state storage media; and/or one or more hybrid magnetic and SSDs. In certain examples, the code 1410 stored in the non-volatile memory can include an operating system and one or more applications or programs that are configured to execute under the operating system. Alternatively or additionally, the code 1410 can include specialized firmware and embedded software that is executable without dependence upon a commercially available operating system. Regardless, execution of the code 1410 can result in manipulated data that may be stored in the data store 1412 as one or more data structures. The data structures may have fields that are associated through colocation in the data structure. Such associations may likewise be achieved by allocating storage for the fields in locations within memory that convey an association between the fields. However, other mechanisms may be used to establish associations between information in fields of a data structure, including through the use of pointers, tags, or other mechanisms.

Continuing the example of FIG. 14, the processor 1402 can be one or more programmable processors to execute one or more executable instructions, such as a computer program specified by the code 1410, to control the operations of the computing device 1400. As used herein, the term “processor” describes circuitry that executes a function, an operation, or a sequence of operations. The function, operation, or sequence of operations can be hard coded into the circuitry or soft coded by way of instructions held in a memory device (e.g., the volatile memory 1404) and executed by the circuitry. In some examples, the processor 1402 is a digital processor, but the processor 1402 can be analog, digital, or mixed. As such, the processor 1402 can execute the function, operation, or sequence of operations using digital values and/or using analog signals. In some examples, the processor 1402 can be embodied in one or more application specific integrated circuits (ASICs), microprocessors, digital signal processors (DSPs), graphics processing units (GPUs), neural processing units (NPUs), microcontrollers, field programmable gate arrays (FPGAs), programmable logic arrays (PLAs), or multicore processors. Examples of the processor 1402 that are multicore can provide functionality for parallel, simultaneous execution of instructions or for parallel, simultaneous execution of one instruction on more than one piece of data.

Continuing with the example of FIG. 14, prior to execution of the code 1410 the processor 1402 can copy the code 1410 from the non-volatile memory 1408 to the volatile memory 1404. In some examples, the volatile memory 1404 includes one or more static or dynamic random access memory (RAM) chips and/or cache memory (e.g. memory disposed on a silicon die of the processor 1402). Volatile memory 1404 can offer a faster response time than a main memory, such as the non-volatile memory 1408.

Through execution of the code 1410, the processor 1402 can control operation of the interfaces 1406. The interfaces 1406 can include network interfaces, such as the network interface 204, 304, 404, for example. These network interfaces can include one or more physical interfaces (e.g., a radio, an ethernet port, a USB port, etc.) and a software stack including drivers and/or other code 1410 that is configured to communicate with the one or more physical interfaces to support one or more LAN, PAN, and/or WAN standard communication protocols. The communication protocols can include, for example, TCP and UDP among others. As such, the network interfaces enable the computing device 1400 to access and communicate with other computing devices via a computer network.

The interfaces 1406 can include user interfaces. For instance, in some examples, the user interfaces include user input and/or output devices (e.g., a keyboard, a mouse, a touchscreen, a display, a speaker, a camera, an accelerometer, a biometric scanner, an environmental sensor, etc.) and a software stack including drivers and/or other code 1410 that is configured to communicate with the user input and/or output devices. As such, the user interfaces enable the computing device 1400 to interact with users to receive input and/or render output. This rendered output can include, for instance, one or more GUIs including one or more controls configured to display output and/or receive input. The input can specify values to be stored in the data store 1412. The output can indicate values stored in the data store 1412.

Continuing with the example of FIG. 14, the various aspects of the computing device 1400 described above can communicate with one another via the interconnection mechanism 1414. In some examples, the interconnection mechanism 1414 includes a communications bus.

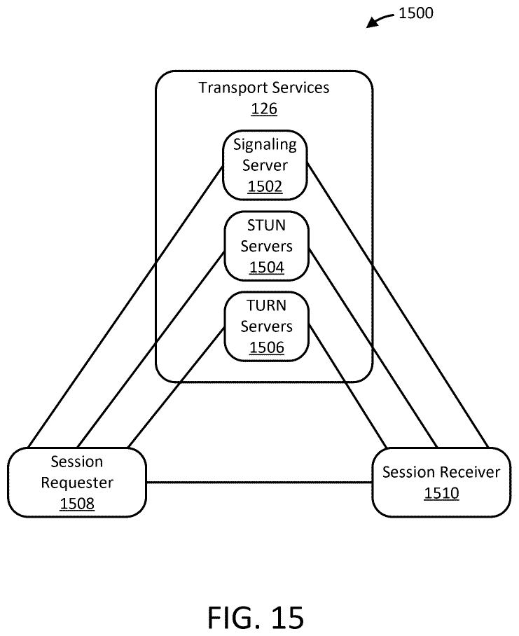

Turning now to FIG. 15, a set of processes 1500 involved in establishing and conducting a communication session (e.g., a real time communication session) in response to selection of a go live control is illustrated as a schematic diagram. As shown in FIG. 15, the set of processes 1500 includes the transport services 126, which are described above with reference to FIG. 7. As is further shown in FIG. 15, the transport services 126 include a signaling server 1502, one or more Session Traversal Utilities for Network Address Translators (STUN) servers 1504, and one or more Traversal Using Relays around Network Address Translators (TURN) servers 1506. The set of processes 1500 further includes a session requester 1508 and a session receiver 1510. The requester 1508 may be the monitor interface 130A or the customer interface 132A described above with reference to FIG. 7. The receiver 1510 may be the surveillance client 136 or a DCS (e.g., the camera agent 138 or another DCS) as described above with reference to FIG. 7.

In some examples, the requester 1508 is configured to communicate with the receiver 1510 via the signaling server 1502 to establish a real time communication session via, for example, a web real time communication (WebRTC) framework. The signaling server 1502 is configured to act as an intermediary or broker between the requester 1508 and the receiver 1510 while a communication session is established. As such, in some examples, an address (e.g., an IP address and port) of the signaling server 1502 is accessible to both the requester 1508 and the receiver 1510. For instance, the IP address and port number of the signaling server 1502 may be stored as configuration data in memory local to the devices hosting the requester 1508 and the receiver 1510. In some examples, the receiver 1510 is configured to retrieve the address of the signaling server 1502 and to register with the signaling server 1502 during initialization to notify the signaling server of its availability for real time communication sessions. In these examples, the requester 1508 is configured to retrieve the address of the signaling server 1502 and to connect with the signaling server 1502 to initiate communication with the receiver 1510 as part of establishing a communication session with the receiver 1510. In this way, the signaling server 1502 provides a central point of contact for a host of requesters including the requester 1508 and a central point of administration of a host of receivers including the receiver 1510.

Continuing with the example of FIG. 15, the STUN servers 1504 receive, process, and respond to requests from other devices seeking their own public IP addresses. In some examples, individual requesters 1508 and the receiver 1510 are configured to interoperate with the STUN servers 1504 to determine the public IP address of its host device. The TURN servers 1506 receive, process, and forward WebRTC messages from one device to another. In some examples, individual requesters 1508 and the receiver 1510 are configured to interoperate with the TURN servers 1506, if a WebRTC session that utilizes the public IP addresses of the host devices cannot be established (e.g., a network translation device, such as a firewall, is interposed between the host devices).

In some examples, a requester 1508 exchanges interactive connectivity establishment (ICE) messages with the STUN servers 1504 and/or the TURN servers 1506. Via this exchange of the messages, the requester 1508 generates one or more ICE candidates and includes the one or more ICE candidates within a message specifying an SDP offer. Next, the requester 1508 transmits the message to the signaling server 1502, and the signaling server 1502 transmits the message to the receiver 1510. The receiver 1510 exchanges ICE messages with the STUN servers 1504 and/or the TURN servers 1506, generates one or more ICE candidates and includes the one or more ICE candidates within a response specifying an SDP answer. Next, the receiver 1510 transmits the response to the signaling server 1502, and the signaling server 1502 transmits the response to the requester 1508. Via the messages, the requester 1508 and the receiver 1510 negotiate communication parameters for a real time communication session and open the real time communication session.

In some examples, while participating in the real time communication session, the receiver 1510 (e.g., the image capture device 110 of FIG. 7) collects audio-visual sensor data (e.g., through a camera and microphone of the image capture device 110) and transmits the audio-visual sensor data to the requester 1508. Further, in these examples, while participating in the real time communication session, the receiver 1510 outputs audio (e.g., via a speaker within the image capture device 110) received from the requester 1508. In a similar fashion, while participating in the real time communication session, the requester 1508 renders (e.g., via a display and speaker in the customer device 122 of FIG. 7) the audio-visual sensor data collected by the receiver 1510. Further, while participating in the real time communication session, the requester 1508 collects audio data (e.g., through a microphone of the customer device 122) and transmits the audio data to the receiver 1510. In this way, a customer or monitoring agent can interact with an individual at a location in real time to help dispose of an event or alarm.

Various inventive concepts may be embodied as one or more methods, of which examples have been provided. The acts performed as part of a method may be ordered in any suitable way. Accordingly, examples may be constructed in which acts are performed in an order different than illustrated, which may include performing some acts simultaneously, even though shown as sequential acts in illustrative examples.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

Examples of the methods and systems discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and aspects discussed in connection with any one or more examples are not intended to be excluded from a similar role in any other examples.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

Having described several examples in detail, various modifications and improvements will readily occur to those skilled in the art. Such modifications and improvements are intended to be within the scope of this disclosure. Accordingly, the foregoing description is by way of example only, and is not intended as limiting.

Descriptions of additional examples follow. Other variations will be apparent in light of this disclosure.

Example 1 is a method comprising: generating an event card for an event detected by a sensor; displaying the event card via a graphical user interface; obtaining updated information pertaining to the event; and updating the event card to reflect an updated status of the event.

Example 2 includes the method of Example 1, wherein obtaining the updated information includes obtaining an indication of a disposition of the event by a monitoring agent, and wherein updating the event card includes updating the event card to reflect the disposition of the event.

Example 3 includes the method of one of Examples 1 or 2, further comprising detecting the event with the sensor.

Example 4 includes the method of Example 3, wherein detecting the event includes detecting a motion event with an image capture device.

Example 5 includes the method of Example 4, further comprising capturing video imagery pertaining to the motion event with the image capture device.

Example 6 includes the method of Example 5, wherein displaying the event card includes providing, via the event card, an access for control for viewing at least a portion of the video imagery.

Example 7 includes the method of any one of Examples 1-6, wherein updating the event card includes updating iconography displayed in the event card and/or a color of the event card.

Example 8 includes the method of any one of Examples 1-7, wherein displaying the event card includes displaying the event card via the graphical user interface presented through a mobile application executing on a mobile computing device.

Example 9 includes the method of Example 8, wherein updating the event card includes updating the event card in real time while the mobile application is executing on the mobile computing device.

Example 10 includes a system configured to perform the method of any one of Examples 1-9.

Example 11 is a method comprising: generating an event card for the event, the event card including information about an event detected by a sensor; displaying the event card within a timeline via a graphical user interface; obtaining updated information pertaining to the event; and updating the event card to show actions by another in relation to the event.

Example 12 includes the method of Example 11, wherein obtaining the updated information includes obtaining an indication of a disposition of the event by a monitoring agent, and wherein updating the event card includes updating the event card to reflect the disposition of the event.

Example 13 is a method comprising: presenting, by a computing device, a timeline of events that occur at a location monitored by a sensor, the timeline including a plurality of different areas of content arranged in sequence by an order of which the events occurred; updating, by the computing device, the content of the timeline in response to a notification from a remote computing device, the update to include information about actions of a monitoring agent; and displaying, by the computing device, the updated content to provide a user of the computing device with transparency about the actions of the monitoring agent.

Example 14 is a method comprising: obtaining data about an event, the event being detected by a sensor at a location; identifying, based on the data, an action taken concerning the event; and updating a control based on the action taken, the control being representative of the event within a graphical user interface.

Example 15 includes the method of Example 14, wherein updating the control includes updating the control while the event is ongoing.

Example 16 includes the method of either Example 14 or Example 15, wherein obtaining the data includes: monitoring a connection between an application hosted on a computing device and a service hosted in a data center environment remote from the computing device; and receiving a message specifying the data via the connection.

Example 17 include the method of any of Examples 14-16, wherein identifying the action taken includes identifying an action taken by a monitoring professional.

Example 18 includes the method of Example 17, wherein: identifying the action taken by the monitoring professional includes identifying a review of the event by the monitoring professional; and updating the control includes changing the control to indicate the review is underway.

Example 19 includes the method of either Example 17 or Example 18, wherein: identifying the action taken by the monitoring professional includes identifying a disposition of the event by the monitoring professional; and updating the control includes changing the control to indicate the disposition.

Example 20 includes the method of any of Examples 14-19, wherein updating the control includes updating a control in a timeline.

Example 21 includes the method of Example 20, wherein updating the control in the timeline includes updating an event card.

Example 22 includes the method of Example 21, wherein updating the event card includes updating text specifying the action taken.

Example 23 includes the method of Example 22, wherein updating the event card includes updating an icon linked with the action taken.

Example 24 includes the method of either Example 22 or Example 23, wherein updating the event card includes adding a control selectable to access at least one image captured by the sensor.

Example 25 includes the method of Example 24, wherein updating the event card include adding a control specifying a number of faces recognized in the at least one image.

Example 26 includes the method of any of Examples 14-24, wherein obtaining the data pertaining to the event comprises obtaining data pertaining to a motion event.

Example 27 is a system comprising: memory; and at least one processor coupled with the memory and configured to obtain data about an event, the event being detected by a sensor at a location, identify, based on the data, an action taken concerning the event, and update a control based on the action taken, the control being representative of the event within a graphical user interface.

Example 28 includes the system of Example 27, wherein to update the control includes to update the control while the event is ongoing.

Example 29 includes the system of either Example 27 or Example 28, wherein to identify the action taken includes to identify an action taken by a monitoring professional.

Example 30 includes the system of Example 29, wherein: to identify the action taken by the monitoring professional includes to identify a review of the event by the monitoring professional; and to update the control includes to change the control to indicate the review is underway.

Example 31 includes the system of either Example 29 or Example 30, wherein: to identify the action taken by the monitoring professional includes to identify a disposition of the event by the monitoring professional; and to update the control includes to change the control to indicate the disposition.

Example 32 includes the system of any of Examples 27-31, wherein to update the control includes to update an event card including specifying the action taken, an icon linked with the action taken, a control selectable to access at least one image captured by the sensor, and a control specifying a number of faces recognized in the at least one image.

Example 33 is directed to one or more non-transitory computer readable media storing sequences of instructions executable to update a graphical user interface (GUI). The sequences of instructions comprising instructions to: obtain data about an event, the event being detected by a sensor at a location, identify, based on the data, an action taken concerning the event, and update a control based on the action taken, the control being representative of the event within a graphical user interface.

Example 34 includes the one or more non-transitory computer readable media of Example 33, wherein the instructions to update the control comprise instructions to update the control while the event is ongoing.

Example 35 includes the one or more non-transitory computer readable media of either of Example 33 or Example 34, wherein the instructions to update the control include instructions to update an event card including specifying the action taken, an icon linked with the action taken, a control selectable to access at least one image captured by the sensor, and a control specifying a number of faces recognized in the at least one image.

Example 36 is a method comprising: obtaining data about an event flagged for handling by at least one monitoring professional, the event being detected by a sensor at a location; identifying, based on the data, an action taken concerning the event; and updating a card based on the action taken, the card being representative of the event within a graphical user interface and including at least one of an icon representative of a type of the event or a control indicating a number of faces of humans detected during the event and selectable to access one or more images depicting the faces of the humans.

Example 37 includes the method of example 36, wherein updating the card includes updating the card while the event is ongoing.

Example 38 includes the method of either example 36 or example 37, wherein obtaining the data includes: monitoring a connection between an application hosted on a computing device and a service hosted in a data center environment remote from the computing device; and receiving a message specifying the data via the connection.

Example 39 includes the method of any of examples 36-38, wherein identifying the action taken includes identifying an action taken by a monitoring professional.

Example 40 includes the method of example 39, wherein: identifying the action taken by the monitoring professional includes identifying a review of the event by the monitoring professional; and updating the card includes changing the card to indicate the review is underway.

Example 41 includes the method of either example 39 or example 40, wherein: identifying the action taken by the monitoring professional includes identifying a disposition of the event by the monitoring professional; and updating the card includes changing the card to indicate the disposition.

Example 42 includes the method of any of examples 36-41, wherein updating the card includes updating a card in a timeline.

Example 43 includes the method of example 42, wherein updating the card in the timeline includes updating the icon to represent that the event was triggered by motion or by detection of a human.

Example 44 includes the method of example 43, wherein updating the card includes updating text specifying the action taken.

Example 45 includes the method of either example 43 or example 44, further comprising capturing, by the sensor, the one or more images.

Example 46 includes the method of any of examples 36-45, wherein obtaining the data pertaining to the event comprises obtaining data pertaining to a motion event.

Example 47 is a system comprising: memory; and at least one processor coupled with the memory and configured to obtain data about an event flagged for handling by at least one monitoring professional, the event being detected by a sensor at a location, identify, based on the data, an action taken concerning the event, and update a card based on the action taken, the card being representative of the event within a graphical user interface and including at least one of an icon representative of a type of the event or a control indicating a number of faces of humans detected during the event and selectable to access one or more images depicting the faces of the humans.

Example 48 includes the method of example 47, wherein to update the card includes to update the card while the event is ongoing.

Example 49 includes the method of either claim 47 or claim 48, wherein to identify the action taken includes to identify an action taken by a monitoring professional.

Example 50 includes the method of example 49, wherein: to identify the action taken by the monitoring professional includes to identify a review of the event by the monitoring professional; and to update the card includes to change the card to indicate the review is underway.

Example 51 includes the method of either example 49 or example 50, wherein: to identify the action taken by the monitoring professional includes to identify a disposition of the event by the monitoring professional; and to update the card includes to change the card to indicate the disposition.

Example 52 is directed to one or more non-transitory computer readable media storing sequences of instructions executable to update a graphical user interface (GUI), the sequences of instructions comprising instructions to: obtain data about an event flagged for handling by at least one monitoring professional, the event being detected by a sensor at a location, identify, based on the data, an action taken concerning the event, and update a card based on the action taken, the card being representative of the event within a graphical user interface and including at least one of an icon representative of a type of the event or a control indicating a number of faces of humans detected during the event and selectable to access one or more images depicting the faces of the humans.

Example 53 includes the media of example 52, wherein the instructions to update the card comprise instructions to update the card while the event is ongoing.

Example 54 includes the media of either example 52 or example 53, wherein the instructions to identify the action taken comprise instructions to identify an action taken by a monitoring professional.

Example 55 include the media of example 54, wherein: the instructions to identify the action taken by the monitoring professional include instructions to identify a disposition of the event by the monitoring professional; and the instructions to update the card include instructions to change the card to indicate the disposition.

As will be appreciated in light of this disclosure, modifications are possible in the described examples, and other examples are possible, within the scope of the claims.

Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular aspect, structure, or characteristic described may be included in at least one example. The appearances of such terms herein are not necessarily all referring to the same example.

1. A method comprising:
obtaining data about an event flagged for handling by at least one monitoring professional, the event being detected by a sensor at a location;
identifying, based on the data, an action taken concerning the event; and
updating a card based on the action taken, the card being representative of the event within a graphical user interface and including at least one of an icon representative of a type of the event or a control indicating a number of faces of humans detected during the event and selectable to access one or more images depicting the faces of the humans.

2. The method of claim 1, wherein updating the card includes updating the card while the event is ongoing.

3. The method of claim 1, wherein obtaining the data includes:
monitoring a connection between an application hosted on a computing device and a service hosted in a data center environment remote from the computing device; and
receiving a message specifying the data via the connection.

4. The method of claim 1, wherein identifying the action taken includes identifying an action taken by a monitoring professional.

5. The method of claim 4, wherein:
identifying the action taken by the monitoring professional includes identifying a review of the event by the monitoring professional; and
updating the card includes changing the card to indicate the review is underway.

6. The method of claim 4, wherein:
identifying the action taken by the monitoring professional includes identifying a disposition of the event by the monitoring professional; and
updating the card includes changing the card to indicate the disposition.

7. The method of claim 1, wherein updating the card includes updating a card in a timeline.

8. The method of claim 7, wherein updating the card in the timeline includes updating the icon to represent that the event was triggered by motion or by detection of a human.

9. The method of claim 8, wherein updating the card includes updating text specifying the action taken.

10. The method of claim 8, further comprising capturing, by the sensor, the one or more images.

11. The method of claim 1, wherein obtaining the data pertaining to the event comprises obtaining data pertaining to a motion event.

12. A system comprising:
memory; and
at least one processor coupled with the memory and configured to
obtain data about an event flagged for handling by at least one monitoring professional, the event being detected by a sensor at a location,
identify, based on the data, an action taken concerning the event, and
update a card based on the action taken, the card being representative of the event within a graphical user interface and including at least one of an icon representative of a type of the event or a control indicating a number of faces of humans detected during the event and selectable to access one or more images depicting the faces of the humans.

13. The system of claim 12, wherein to update the card includes to update the card while the event is ongoing.

14. The system of claim 12, wherein to identify the action taken includes to identify an action taken by a monitoring professional.

15. The system of claim 14, wherein:
to identify the action taken by the monitoring professional includes to identify a review of the event by the monitoring professional; and
to update the card includes to change the card to indicate the review is underway.

16. The system of claim 14, wherein:
to identify the action taken by the monitoring professional includes to identify a disposition of the event by the monitoring professional; and
to update the card includes to change the card to indicate the disposition.

17. One or more non-transitory computer readable media storing sequences of instructions executable to update a graphical user interface (GUI), the sequences of instructions comprising instructions to:
obtain data about an event flagged for handling by at least one monitoring professional, the event being detected by a sensor at a location,
identify, based on the data, an action taken concerning the event, and
update a card based on the action taken, the card being representative of the event within a graphical user interface and including at least one of an icon representative of a type of the event or a control indicating a number of faces of humans detected during the event and selectable to access one or more images depicting the faces of the humans.

18. The one or more non-transitory computer readable media of claim 17, wherein the instructions to update the card comprise instructions to update the card while the event is ongoing.

19. The one or more non-transitory computer readable media of claim 17, wherein the instructions to identify the action taken comprise instructions to identify an action taken by a monitoring professional.

20. The one or more non-transitory computer readable media of claim 19, wherein:
the instructions to identify the action taken by the monitoring professional include instructions to identify a disposition of the event by the monitoring professional; and
the instructions to update the card include instructions to change the card to indicate the disposition.
